(19) United States
(12) Patent Application Publication
(10) Pub. No.: US 2014/0032331 A1
(43) Pub. Date: Jan. 30, 2014

(54) METHOD FOR INTERACTING WITH CUSTOMERS AT A POINT OF SALE FOR GOODS OR SERVICES

(71) Applicant: LE METIER DE BEAUTE, (US)

(72) Inventors: Richard BLANCH, Hopewell Junction, NY (US); Athanasios G. CHRIST, Vienna, VA (US); Daniel S. ROBEY, Falls Church, VA (US)

(73) Assignee: LE METIER DE BEAUTE, NEW YORK, NY (US)

(21) Appl. No.: 13/741,068

(22) Filed: Jan. 14, 2013

Related U.S. Application Data
(60) Provisional application No. 61/586,406, filed on Jan. 13, 2012.

(51) Int. Cl. G06Q 30/02

(52) U.S. Cl. CPC G06Q 30/0269
USPC 705/14.66; 705/14.4; 705/14.49

(57) ABSTRACT

A system for product promotion made up of an administrator subsystem that provides input by way of various modules, an agent subsystem that provides input by way of various modules, and a customer subsystem that provides input by way of various modules where the product promotion output is determined by the modules of the three subsystems and data provided to or generated from the system is stored on a non-transitory computer readable medium.

### BACKGROUND

There is currently a need in the market place for an interactive touched-based software application alternatively operating on a touch-sensitive countertop computing device or touch-sensitive tablet computing device that:
Allows customers to browse a company's product line, see related products and view related video on the product.
Allows for a sales associate to memorialize the application of one or more cosmetic products to a customer's face by, for each such cosmetic product: (a) selecting such cosmetic product from a list of cosmetic products displayed by the software application; (b) selecting an area of a representative illustration of a customer's face displayed by the software application to designate application of such cosmetic product to such area; then (c) configure such cosmetic product with respect to quantity, color and other attributes through means provided by the software application; for the purpose of (d) modifying then recording such representative illustration.
Allows for a sales associate to memorialize the application of one or more cosmetic products to a customer's face by recording the identity and configuration of each such cosmetic product.
Allows for a consultant to provide skin care analysis and recommendations by capturing, tracking and comparing images of the customer's face using a medical grade camera over multiple visits.
Captures and stores customer identification information and sales associate authored notations associated with consultations and skin care analysis in Web-hosted data stores for retrieval and personalization of future interactions by customers with the software application.
Provides a promotional loop of images and video when the device is not in use.
Stores certain metrics on application use in Web-hosted data stores.

Furthermore, there is a need for a software application designed for use with mobile electronic devices that operates cooperatively with the aforementioned touch-based software application that:
Allows for a customer to acquire and display images of goods that such customer believes to be representative of his or her tastes in general, or with respect to such type or category of good.
Allows for a customer to acquire and display images of his or her face upon application of makeup by a sales consultant.
Allows for a customer to associate an image or his or her face with other records maintained by the aforementioned touch-based software application that are created by a sales associate to memorialize the application of makeup by such sales associate to such customer's face.

### SUMMARY OF THE INVENTION

For the purposes of this application the following terms should be understood as defined below:
“Access Control Module” shall mean a Module effectuated by an Administrator through the Administrator Subsystem with which such Administrator can allow or revoke User access to the System and access or modify System Users' credentials.
“Administrator” shall mean a System User that is a person that has responsibility over the function of the System and is engaged in the promotion of Products through the System.
“Administrator Subsystem” shall mean a component of the System comprised of software running on a computing device that is operated by an Administrator for the purpose of: (1) analyzing interactions between Agents and Customers facilitated by the Agent Subsystem; (2) analyzing Customer actions taken during use of the Customer Subsystem; and (3) generally managing all aspects of the System.
“Agent” shall mean a System User that is a person engaged in the sale of one or more Products or in the provision of information to Customers with respect to the value, suitability to such Customer's needs and intended use of such Product(s). An Agent is, for example, a person using the system to provide a service to the customer, for example, a sales person or a dermatologist. The term Employee may also refer to an agent.
“Agent Analytics Module” shall mean a Module effectuated by an Administrator through the Administrator Subsystem with which such Administrator can measure the performance of Agents with respect to the promotion of Products.
“Agent Subsystem” shall mean a component of the System comprised of software running on a computing device that is operated by an Agent in service to a Customer for the purpose of assisting such Customer's purchase decision with respect to a Product.
“Collection” shall mean a Customer-organized and named collection of images or other media assets.
“Collection Analytics Module” shall mean a Module effectuated by an Administrator through the Administrator Subsystem with which an Administrator can determine the prevalence of images of Products and other assets associated with Products acquired by Customers through the Collection Module.
“Collection Module” shall mean a Module effectuated by a Customer through the Customer Subsystem with which a Customer acquires images or other media assets using a Customer Subsystem attached camera or using other means and organizes these images or other media assets into Collections for later retrieval and presentation. Customers can use the Collection Module to share Collection images or media assets with third parties through social networks such as Facebook and Twitter.
“Collection Display Module” shall mean a Module that causes the display of Collection images or other media assets through the Agent Subsystem.
“Configurator Module” shall mean a Module effectuated by an Agent through the Agent Subsystem with which such Agent advises a Customer with respect to optimal use of a Product. Through its use, a Configurator Module displays information representing the foregoing advice, which information may include Agent-entered or recorded notations and identifies Products, the method of such Products' application and/or use, order of such Products' use and other Product-related information.
“Configurator Display Module” shall mean a Module that causes the display of Configurator Module display information through the Customer Subsystem. Customers can use the Configurator Display Module to share the foregoing information with third parties through social networks such as Facebook and Twitter.
“Consultation” shall mean an interaction between an Agent and a Customer incorporating the System. For example, in a preferred embodiment a Consultation refers to the interaction between an Agent and a Customer at a point of sale where the System is used to, for example, interact with Customer Collections, display Products data, or virtually assist with a make over conducted on the Customer. For example, in a preferred embodiment, a Consultation refers to an interaction with a person shopping for beauty products and a person working in the store where the Customer is shopping. In another embodiment, a consultation may be between a doctor (Agent) and a patient (Customer) where the Consultation is a medical consultation or procedure.
“Content Management Module” shall mean a Module effectuated by an Administrator through the Administrator Subsystem with which such Administrator can manage content displayed in the System, including Product information.
“Customer” shall mean a System User that is an individual motivated by an interest to learn more about or purchase Products. For example, a Customer is the person that is generally subject of the inputs during a Consultation, some possible exceptions being the notations made by the Agent and date/time/location stamp generated by the System during a Consultation.
“Customer Analytics Module” shall mean a Module effectuated by an Administrator through the Administrator Subsystem with which such Administrator can analyze the actions taken by Customers with respect to the System.
“Customer Subsystem” shall mean a component of the System comprised of software running on a computing device that is operated by a Customer for the purpose of memorializing that Customer's general aesthetic tastes and preferences with respect to specific Products.
“Guide Module” shall mean a Module effectuated by an Agent through the Agent Subsystem with which such Agent displays Product information to a Customer.
“LMDB” shall mean Le Métier de Beauté, a brand of cosmetics manufactured and sold by Le Métier Tribeca LLC.
“Module” shall mean a discrete feature or set of inputs, displays and functions with which System Users interact for the purpose of directly or indirectly encouraging the purchase of Products by Customers.
“My Face” shall mean a Configurator Module which displays either a virtual face or a image of a Customer's face. The My Face display may optionally include a series of images showing different stages of cosmetics products application including, for example, data indicating at which stage in the cosmetics application process the specific My Face image was produced, data indicating what products are shown in the specific My Face image being viewed, the time and date the specific My Face image was produced. In some embodiments, the specific My Face image with be a short video or a marked segment of a longer video.
“Needs/Suitability Analyzer Module” or “NSA Module” shall mean a Module effectuated by an Agent through the Agent Subsystem with which such agent assesses a Customer's needs with respect to a Product and/or evaluates and qualifies the potential value of a Product to a Customer and/or determines the suitability of a Product to a Customer. Through its use, a NSA Module displays information representing and substantiating the foregoing assessment.
“NSA Display Module” shall mean a Module that causes the display of NSA Module display information through the Customer Subsystem. Customers can use the NSA Display Module to share the foregoing information with third parties through social networks such as Facebook and Twitter.
“Product” shall mean a good or service sold by an Agent.
“Product Analytics Module” shall mean a Module effectuated by an Administrator through the Administrator Subsystem with which such Administrator can measure the frequency of Product information presentation in the System as through the Guide Module, and by proxy Customer interest in Products.
“Product Offer Module” shall mean a Module that causes the display of Product promotional content to Customers through the Customer Subsystem.
“Product Promotion Module” shall mean a Module effectuated by an Administrator through the Administrator Subsystem with which such Administrator can cause the explicit promotion of a Product to Customers through the Product Offer Module as a result of findings through use of the Collection Analytics Module and Product Analytics Module.
“User” shall mean an Administer, Agent, or Customer.
“User Interface Device” shall mean any deceive that allows a User to access the system, for example, a system terminal or networked computer device. A networked computer is an internet capable electronic device.

The system of the current application comprises the combination of the Administrator Subsystem, the Agent Subsystem and the Customer Subsystem.

### The Administrator Subsystem

The Administrator Subsystem is operated by administrator who has responsibility over the function of the System and is engaged in the promotion of products through the System. Administrator subsystem is used to analyze interactions between Agents and Customers facilitated by the Agent Subsystem, to analyze Customer actions taken during use of the Customer Subsystem, and to manage all aspects of the System.

For example, in some embodiments the administrator User may use the following modules:

The Administrator User may the access control module to allow or revoke User access to the system and access or modify a system Users credentials.

The Administrator User may use the agent analytics module to measure the performance of Agents with respect to the promotion of Products.

The administrator User may use the Collection Analytics Module to determine the prevalence of images of Products acquired by Customers through the Collection Module.

The Administrator User may use the Content Management Module to manage content displayed in the System, including Product information.

The Administrator User may use the Customer Analytics Module to analyze the actions taken by Customers with respect to the System.

The Administrator User may use the Product Analytics Module to measure the frequency of Product information presentation in the System as through the Guide Module, and by proxy Customer interest in Products.

The Administrator User may use the Product Promotion Module to cause the explicit promotion of a Product to Customers through the Product Offer Module as a result of findings through use of the Collection Analytics Module and Product Analytics Module.

Other modules are easily incorporated into the system for Administrator use as needed.

Administrators can access and interact with the system at a system terminal or via a web browser. For example, in some embodiments the administrator accesses the system via cloud computing platforms, for example, MICROSOFT AZURE or PARSE.

The hardware of the system is comprised of networked computers that can securely access the system data. Any computer with internet access can be a system computer. A system terminal is a networked computer in a place of business or at a point of sale that has access to the system data and may also optionally have accessory hardware such as a digital camera for capturing images or video.

The modules of the Administrator Subsystem may also be accessed via a networked computer or system terminal as discussed above.

### The Agent Subsystem

The Agent Subsystem is operated by an Agent and is comprised of software running on a computing in service to a Customer for the purpose of assisting such Customer's purchase decision with respect to a Product.

In some embodiments, the agent User may use the following modules:

An Agent User may use the Collection Display Module to display Collection images or other media assets through the Agent Subsystem, for example, in some embodiments the Collection Display Module appears as a panel in the My Face Configurator Module.

An Agent User may use the Configurator Module to advises a Customer with respect to optimal use of a Product. Configurator Module displays information representing the foregoing advice, which information may include Agent-entered or recorded notations and identify Products, method of Product application and/or use, order of Product use and other Product-related information. For example, the My Face (the name of the Configurator Module in some embodiments of the system) which is a virtual application of LMDB cosmetic products including a virtual face or real customer image with various cosmetics products applied.

An Agent User may use the Guide Module to display Product information to a Customer. For example, LMDB product information, including product images, descriptions and video.

An Agent User may use the Needs/Suitability Analyzer Module or NSA Module to assesses a Customer's needs with respect to a Product and/or evaluates and qualifies the potential value of a Product to a Customer and/or determines the suitability of a Product to a Customer. Through its use, a NSA Module displays information representing and substantiating the foregoing assessment. For example, skin analysis from a third party, for example, Profect Medical Technologies.

Other modules are easily incorporated into the system for Agent's use as needed.

Agents can access and interact with the system at a system terminal or via a web browser. In the preferred embodiment an Agent will access the system at a system terminal. In the preferred embodiment the system terminals used by the agents are touch-enabled computer interface devices which optionally have integrated periphery devices, for example, printers, cash registers, credit card processing machines, digital cameras for capturing image or video data, or other devices common to a commercial interaction with a customer. In some embodiments the touch-enabled computer interface device is a tablet computing device. In some embodiments the touch-enabled computer interface device is Samsung SUR 40 for Microsoft Surface or Samsung Slate Series 7. In some embodiments, the touch-enabled computer interface device is a CPU connected to a touch screen monitor, for example, Touch Revolution Tru32 monitor. In some embodiments the Agents accesses the system via cloud computing platforms, for example, MICROSOFT AZURE or PARSE.

The modules of the Agent Subsystem may also be accessed via a networked computer or system terminal as discussed above.

### The Customer Subsystem

The Customer Subsystem is operated by an Customer and is comprised of software running on a computing device for the purpose of memorializing that Customer's general aesthetic tastes, preferences with respect to specific Products.

In some embodiments, the Customer User may use the following modules:

A Customer User may use the Collection Module to acquire images or other media assets using a Customer Subsystem attached camera or using other means, for example, the internet, and organize these images or other media assets into Collections for later retrieval and presentation. Customers can also use the Collection Module to share Collection images or media assets with third parties through social networks, for example, FACEBOOK and TWITTER.

A Customer User may use the Configurator Display Module to display the Configurator Module display information through the Customer Subsystem. Customers can use the Configurator Display Module to share the foregoing information with third parties through social networks for example, FACEBOOK and TWITTER.

A Customer User may use the NSA Display Module to display information through the Customer Subsystem. Customers can use the NSA Display Module to share the foregoing information with third parties through social networks for example, FACEBOOK and TWITTER.

Other modules are easily incorporated into the system for Customer's use as needed.

A Customer User may use the Product Offer Module to display of Product promotional content to Customers through the Customer Subsystem.

A Customer may access and interact with the Customer Subsystem at a system terminal or via a web browser. For example, in some embodiments the customer accesses the system via cloud computing platforms, for example, MICROSOFT AZURE or PARSE.

The hardware of the system is comprised of any networked computer that can securely access the Customer Subsystem. In some embodiments, accessing the system is facilitated by an iOS application that can be downloaded/installed on a Customers personal computing device and which allows the Customer to securely access the modules of the Customer Subsystem.

Some embodiments of the system include the following features:

1. A set of hosted administrative services that allow manipulation of User and system data including:
A. Storing information, for example, customer credentials, Agent credentials, collection images, skin Analysis images, consultation product lists consultation location data, participants and notations data, face chart images, product images with optional associated video and descriptive text, and certain User participation and usage data;
B. Processing system security and access control information, for example, by creation/configuration of connection tokens (Usernames or other identifier that is understandable to both the system and to third party software) and creation/configuration of mobile application connection tokens;
C. Processing User information and system content, for example, creation of Agent account credentials and edit of Agent account information, management of images, management of various forms of the system and mobile application content, and analysis of use of the system and mobile application.

2. A User interface compatible with existing well known platforms, for example, Microsoft's WINDOWS PRESENTATION FOUNDATION, Microsoft's SILVERLIGHT plug-in services and Microsoft's PIXELSENSE touch computing platform; and/or APPLE's mobile operating system, specifically for the iPHONE and iPAD mobile computing devices; and

3. Processing of User data in the User interface and allowing for presentation and publication of specified User data collected with and/or generated by the User interface.

Some embodiments of the system also include the following features:
1. The ability to create, read, update and delete functions available to Administrators with respect to User account information and User-generated data;
2. User authentication services.
3. The presentation of product information to Customers using the system (with respect to each product);
4. The acquisition of images by Customers and organizing the images into a Collection.
5. The presentation of Customer-acquired images;
6. The provision by an Agent of Consultation regarding various services or products, for example, cosmetics to a Customer. For example, a list of products is assembled and a rendering of the effect of applying these products is produced on a Face Chart; and
7. The analysis of Customer facial skin attributes over time using the system.

The User interface with the system is accomplished using system terminals or a networked computing device, for example, a computer, cell phone or other internet accessing electronic device.

In a preferred embodiment, the system terminal enables consultations to be performed and Customers may use networked computing devices to review or interact with the data created during the consultation. The system provides a step for confirming Agent and Customer's identification through a log in process, for example, providing a User name and password.

The system displays a category selector that allows Agents and/or Customers to browse products and information related to the products that are known to the system. Selecting a product causes a content panel to appear, which may include images, text and video.

The system also provides for a consultation feature which includes at least one of the following four functional areas:
1. Customer collections, or a panel that allows Agents and/or Customers to browse images saved to customer collections;
2. A product configurator;
3. A face chart/customer image; and/or
4. A notations section.

An Agent can create a new consultation for a logged-in Customer by using an interfacing device of the system, for example a system terminal. Once a consultation is created, an Agent can select, configure and virtually “apply” various products to a face chart where the face chart is an image displayed as a proxy for the Customer's face or a real image of the Customers face.

In a preferred embodiment the Agent would also simultaneously be actually applying products to the customer's face in such a way as to mach the face chart. In some embodiments, data regarding the products used, where the products were used on the customer, how the products where used on the customer, in what order the products were used on the customer, and images and/or video of the customer at various points of the consultation could all be generated and/or collected during the consultation. The data from collected during the consultation is stored on the system and can be accessed by the User at a time in the future. The consultation therefore serves to memorialize the actions taken during the customer's time with the Agent.

The system can take an image or video of the customer and store this photo on the system. The Customer can then access the photo at a time in the future. The system can also organize the image or video data for ease of Customer use, for example, the image or video data can be organized into Collections. In some embodiments, the image or data of the Customers face is call the My Face Collection. The Collections are optionally displayed on the User interface device. The data from the collections also can be used to generate a face chart.

The system also provides the ability for notations to be made, for example, the location of the particular Consultation, the date and time of the Consultation and the identity of the Agent. A User may also enter and edit text notes that pertain to the Consultation or free draw on the Face Chart or other images displayed during the Consultation.

The notations section also enables an Agent may identify a guest makeup artist that either assisted with or fully performed the associated Consultation. In some embodiments, when a makeup artist is identified, the makeup artist is recognized as the Agent by the system at least with respect to the information disclosed in the notations section.

Additionally, the system allows for consultations to be performed without an Agent having logged in to the system. In these embodiments, no Agent is identified in the notations section of a consultation.

In some embodiments, the Consultations may be saved upon completion and may be reviewed at a future date using a system terminal when both the Agent and customer associated with such Consultation are logged in to the surface application. In some embodiments only the Customer must be logged in to view the previous Consultation data.

In some embodiments a skin analysis is performed by the system. In some embodiments an Agent may perform a skin analysis for a customer. In some embodiments, the Agent may access the skin analysis feature through user interface. In some embodiments, a data of previously-saved skin analysis events are displayed for the Agent and Customer to optionally edit and review. The option to start a new skin analysis is also presented.

A new skin analysis generates pictures of the Customer's face. The system connects with a third-party image acquisition system, for example, PROFECT MEDICAL TECHNOLOIES, LLC (“Hilbert”). In the embodiments using Hilbert, Hilbert produces natural light and polarized light images of the customer's face (the “Primary Images”), then performs processes to transform the forgoing images into two additional, novel renderings of the original two images for the purpose of identifying characteristics of the customer's facial skin.

Once acquired, the primary images are time and date stamped and the natural light primary image is displayed, for example, as a thumbnail and used to identify acquired images. The Agent can then drag any thumbnails to a visual panel in the system used to assemble images for viewing in full-size format.

In some embodiments, full-size images may be viewed alone, in side-by-side comparison, or in a “slide show” format showing the progression from the earliest image acquired to the most recent image acquired. Thus, in some embodiments, the User experience for previously initiated skin analyses may be edited by adding more recently acquired images in order to display the progression of facial skin condition over time.

In some embodiments, live video feed is available on unit to align Customer into proper position. Once aligned, the service provider, for example, an Agent will take skincare images. In some embodiments, four images are taken: daylight, polarized, cross polarized infrared and UV.

In some embodiments, pigmentation and vascular conditions may be automated via image processing of blood concentration, red and brown concentration analysis by the system or by a third party system.

In some embodiments, analysis of skin elasticity and texture may be performed by the system or by a third party system.

In some embodiments, quantitative and visual assessment of ultraviolet data indicating acne, solar damage, melasma and dehydration may be conducted by the system or by a third party system.

In the embodiments, skin lesions, scar tissue and wrinkle length are measured.

In the embodiments, images are cross reference to provide side by side comparisons. Images can be zoomed into to deliver closer detail. Both images scroll can optionally be zoomed simultaneously.

In some embodiments, once a User has multiple images stored into database, timelapse animation can be delivered giving User true reference to demonstrate clinical improvement and progression of existing conditions.

In some embodiments, info graphics give customers visual data of skin analysis and progression and can give comparative data to pool of participants, for example, your skin ranks 85% better than others in your age group.

In some embodiments, visual data can be delivered to provide real time progression as timelapse is being viewed (ie, skin age decreases as images cycle through animation). An Agent can mark areas of interest and place notes within system for future reference.

In some embodiments, an Agent or the system can provide a skincare regimen is built based on analysis data and skin interests or concerns. Regimen includes, for example, recommended application techniques by dermatologist.

Analysis and regimen may be pushed to Customers account via email address or accessed by the Customer though a internet accessible computer device.

In some embodiments of the system, the system terminal can function as a point of sale device where products used or selected during the Consultation can be purchased by a customer. In some embodiments, the system can offer reduced prices and/or other special offers according to the products selected for purchase. In some embodiments the Agent can select from generic special offers to be applied to Customize the sale to the Customer, for example, offering the Customer a price discount if multiple items are purchased.

In some embodiments the system includes:
A means to personalize the output of a Consultation by adding images of the Customer taken before and after the Consultations.
Onsite video Consultations that allow the makeup artist to record the Consultation, automatically track the products applied and send the resulting video and information to the Customer's profile to be viewed online at their leisure.
Remote skin-care analysis via video conferencing

A User can access and interact with the system remotely using a networked computer. In some embodiments, mobile electronic devices with access to the internet interact and share information with the system. For example, information related to a previous Consultation could be accessed and/or saved on a networked computer for viewing. In some embodiments, the Customers can collect images of interest that they believe are germane to their skin care and/or reflective of their fashion-related preferences and send this data to the system where it can be reviewed at a consultation or on a networked computer.

A Customer accessing the system from a networked computer will still need to pass a security check. In some embodiments, Customers create a User account by simply entering an email address. A hash function may be applied to the email address to create a private password that the customer never needs to use; it is passed automatically by the system when authentication is required. In some embodiments a member must login using a member name and password to access the system.

The system provides customers the ability to acquire images and organize them into Collections. Images may be acquired by either using the native camera of the device on which the Customer is running the system (i.e., the Customer can take a picture with his or her cell phone) or by selecting a previously-acquired image stored in a local camera roll/album (i.e., from the internet).

Upon acquiring an image, customers designate an existing, or create a new, Collection with which to associate the image. In some embodiments, images are upload to and saved in cloud storage.

Images may be viewed, deleted, or shared via third party web sites, for example, the FACEBOOK application.

In the preferred embodiment, the system provides one default collection named “My Face” wherein all images taken as replacements for the default Face Chart image associated with a consultation are stored. Customers may manually associate images with the my face collection as well using the standard means available for associating any image with any collection.

Customers using the system can cause for consultations and/or individual images associated with a collection to be shared with third party social networking websites, for example, FACEBOOK.

In some embodiments, the products may be displayed using a fixed template for the product. The template may include dynamic sections for related products, categories and assets. For example, the template may provide pictures of the product, information related to the product, for example, ingredients or materials used in the product, and information related to the store in which the product is being sold, for example, price, sales, or special offers.

Different variations of a product may also be optionally displayed either before or after the product is select by a User. These variations include, for example, different shades or colors the product is available in. Similar products to the selected product may also be displayed.

Categories are used to group products into product lines for navigation purposes. Consultations, products, User images or videos, Face Charts, skin analysis, Agent information, administrative tools and other information all may be separated into categories by either manually a User of the system or automatically by the system depending on the circumstances. For example, if a Customer is logged in and participates in a Consultation, data generated during the Consultation can be automatically categorized by the system with including a date/time/location stamp.

In some embodiments of the system, a video of a Consultation may be captured and stored using the disclosed processes and configurations.

Some embodiments of the system may contain the following features:
Centralized content management and distribution including:
   A centralized content management system that provides full approval of workflow facilities.
   Scheduled targeted content updates allowing administrators to target specific devices, regions or global updates.
   Automated application deployment allowing software to be updated from a central location at a scheduled time for a specific devices, region or globally.
Web and mobile integration including:
   Integrating content produced on system with the Customer's online profile.
   A means for the Customer to browse their profile, Consultations and skin care analysis on the web.
   Allowing the Customer to share their Consultations and favorite products over social media (FACEBOOK, TWITTER, etc.)
   Product updates and suggestions based on usage information gathered from Consultations, skin care analysis and product views on system.
Centralized metrics and analytics
Point-of-sale and loyalty functionality like the ability to shop directly on the unit.
Content recording and basic editing facilities to allow for the generation of content by Agents after store hours
Agent specific content and training materials.

In some embodiments, the process of connecting (sync) the digital counter to a mobile electronic device is done through an internet connection. However, in the embodiments where an internet connection is not available or not preferred, a way to connect a mobile electronic device to the digital counter is still desirable. This is accomplished by creating a local wireless network with a router attached to the digital counter. This allows a Customer to connect a mobile electronic device to the network. The mobile electronic device communicates to the service running on the digital counter in order sync data, for example, images with it.

In some embodiments, synching of the mobile device with the system is accomplished by placing the phone down and detecting that accelerometer change and the blob generated by the phone. Many mobile electronic devices are also capable of detecting a User swinging the device downwards through the use of a built in accelerometer (bump) which will send that device to the sync service. If the service detected a bump both on the digital counter and the mobile electronic device within an acceptable range of time, it would pair up those two devices in a session.

In other embodiments, button taps on each of the devices are used instead of bumping them. For example, the Users of the mobile electronic device and digital counter each tap a sync button at a similar time and place which allows the devices to sync. This is to prevent the Users from damaging their mobile electronic devices and the digital counter when they bumped them and acts as an alternative to Users with mobile electronic device incapable of bump syncing.

In some embodiments data relating to products are provided. In the preferred embodiment the products are beauty products. In other embodiments the products can be, for example, sporting equipment, clothes, toys, electronics, automotive parts, or furniture can be processed and displayed by the system.

In some embodiments, a print out is provided at the counter which can be given to customer at the end of the consultation with list of products used, steps and face chart/finished look image.

### BRIEF DESCRIPTION OF DRAWINGS

FIG. 1 illustrates the functions available to customers and some functions available to the Agents in some embodiments of the system.

FIG. 2 illustrates the additional functions available to the Agent in some embodiments of the system.

FIG. 3 illustrates the functions available to the Administrator in some embodiments of the system.

FIG. 4 illustrates the system functions in some embodiments of the system.

FIG. 5 shows an overview of the mobile application in some embodiments of the system.

FIG. 6 shows a mobile electronic device syncing with system in some embodiments of the system.

FIG. 7 shows data being transferred from the mobile electronic device to the system in some embodiments of the system.

FIG. 8 illustrates a consultation in progress in some embodiments of the system.

FIG. 9 shows a consultation history display in some embodiments of the system.

FIG. 10 shows various displays of the mobile interface in some embodiments of the system.

FIG. 11 shows a mobile electronic device syncing with a third party website in some embodiments of the system.

FIG. 12 shows various examples of consultation interface in some embodiments of the system.

FIG. 13 shows an example of a consultation interface in an embodiment of the system.

FIGS. 14-18 show various workflow processes of some of the embodiments of the invention in some embodiments of the system.

FIGS. 19-51 show various static interfaces with some of the embodiments of the system.

FIGS. 52-58 show various static interfaces with a mobile communication device in some embodiments of the system.

FIG. 59 is omitted.

FIGS. 60-62 show various static interfaces with a mobile communication device in some embodiments of the system.

FIG. 63 shows the three subsystems (Administrator, Agent, and Customer) sending and receiving data to a user interface device.

### DETAILED DESCRIPTION OF DRAWINGS

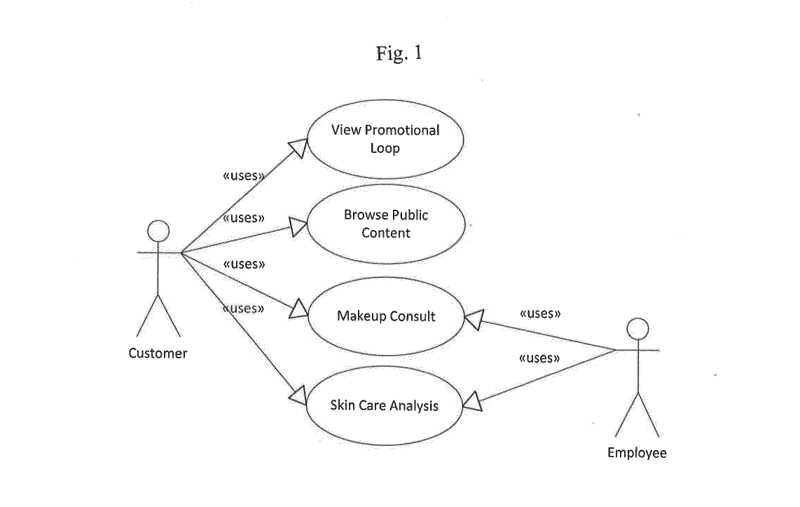

FIG. 1 illustrates the functions available to customers and some functions available to the Agents in some embodiments of the system.

### Browse Public Content

Navigate a menu and pages of content that describe products and categories currently available.
The User can place a product with a specialized tag on the device to find out additional information about the product. This at least partially the same information that may be found in the browser.
The User may act alone, or collaboratively work with a makeup artist.

### Makeup Consultation

Collaboratively work with a makeup artist to select multiple products and apply them to a predetermined image.
Store the consultation with their profile on the device.
Load a present makeup consultation.
This functionality is only available if an Agent is logged in.

### Skin Care Analysis

Participate in a skin care analysis session with an analyst (Agent) to track and compare the appearance of their skin over a period of time.
This functionality is only available if an Agent is logged in.

### View Promotional Loop

View promotional images and video in a loop until they are prepared to interact with the device.

Once they interact with the device the customer is taken to a main menu of options available to them.

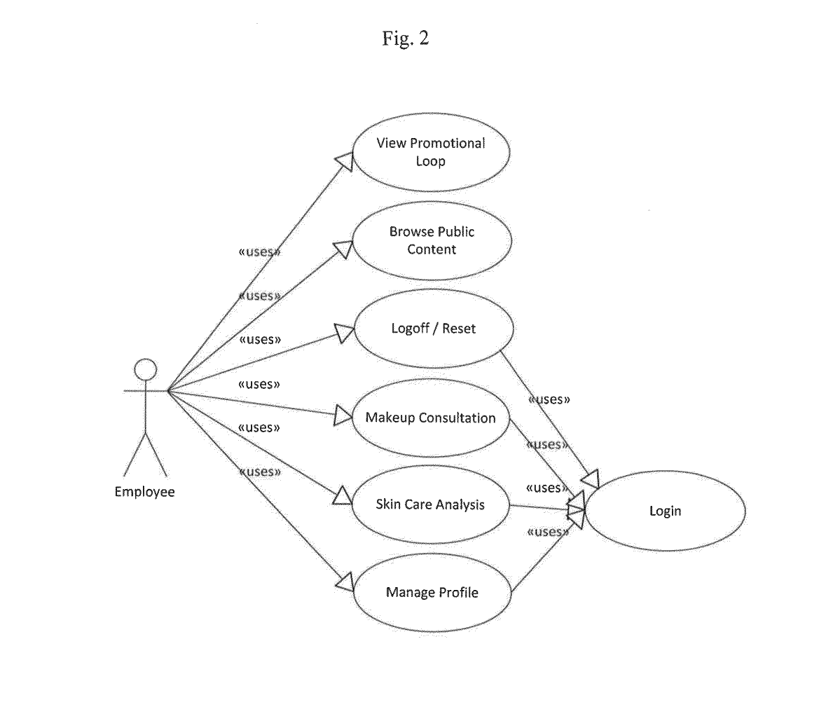

FIG. 2 illustrates the additional functions available to the Agent in some embodiments of the system.

Please note that the “Browse public content”, “Makeup Consultation”, “Skin Care Analysis” and “View Promotional Loop” are the same as described above for the customer.

### Login

Agent authenticates by placing a security card down on the surface of the device or by using a specific gesture and last name in case they do not have the card available.
Device enters “Agent mode” giving access to a restricted access menu of the options:
   Makeup Consultation
   Skin Care Analysis
   Manage Profile

### Logoff/Reset

The Agent removes their security card and a timed warning and the ability to logout immediately
Logoff can also be activated via a timeout of inactivity even if the card is on the device.
Once logged out the system goes back to the promotional loop.

### Manage Profile

Agent can add a new profile, including name and email address
Agent can retrieve existing profiles using customer's email address
Agent can associate a consultation or skin care assessment with a profile
Agent can view a profile along with the consultations and skin care assessments associated with them.

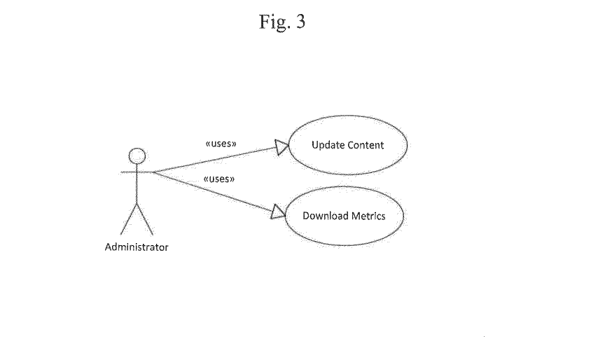

FIG. 3 illustrates the functions available to the administrator in some embodiments of the system.

### Update Content

An administrator creates a new content package by manually creating the deployment package.
The content package is added to the system by manually copying it to the device and resetting it.
   The content package includes product information, information on the promotional loop and all assets associated with those items.

### Download Metrics

An administrator is be able to manually copy metrics data from the local data store for offline analysis.
   This is not be part of the system itself but by accessing the data store directly.

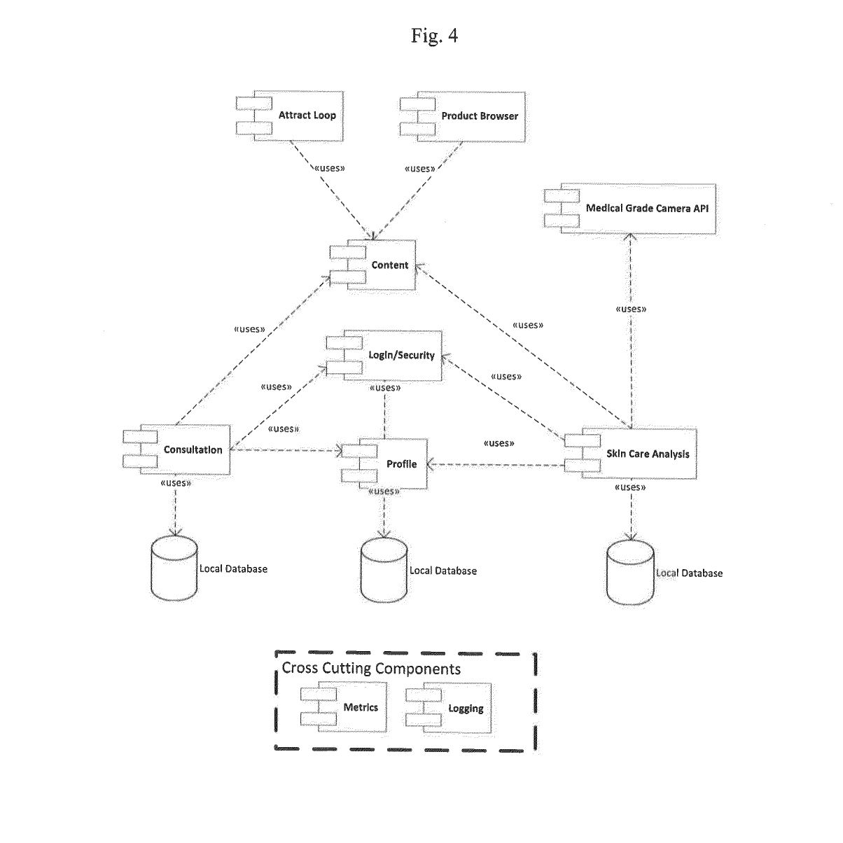

FIG. 4 illustrates the System in some embodiments of the system.

The System comprise the following components:
Attract Loop
Product Browser
Content
Consultation
Skin Care Analysis
Profile
Login (Agent login)
Cross Cutting Components: Metrics & Logging

FIG. 4 illustrates the System functions, in some embodiments of the system, which comprise the following.

### Attract Loop

The attract loop is a non-interactive loop that represents a list of assets that are cycled through when the device is not being interacted with.

In the Surface counter application, the attract loop begins when the application is idle and stop immediately when someone interacts with the application. When the application goes idle again the attract loop may start in a random location in an attempt not to starve any content.

The orientation of the display may randomly invert so as to service both sides of the counter, however, it is recommended that orientation-neutral assets be used.

In one embodiment, only images of and video of the following types are supported in the attract loop:
Images: jpg, png (1920×1080 pixels or less)
Video: mp4 (1080 p or less)

All images and video are be stretched to full screen size. In other embodiments other file types may be used and may be sized as desired.

### Login/Security

The application may contain an identification mechanism to allow an Agent to identify themselves to the device and access the functionality that requires an Agent to be present (e.g. perform consultations, or view customer records).

The default mechanism is for the Agent to place a security card printed with a byte tag onto the device. As long as the tag is on the device, the Agent may be logged in. If the attract loop is activated because of a timeout, the card must be removed and re-added before it is recognised again.

An alternative mechanism to allow an Agent to log in is provided that may consist of manual entry of the Agent's security code along with their last name. This may be used in the case where a security card has been lost.

Note: This provides very minimal security as no pin or password verification is used. A risk that one customer may be able to look up another customer's profile exists and may need to be addressed by some other form of security. Other forms of security are well known in the art and are compatible with the embodiments described herein.

### Main Menu

The main menu for the application provides access to the other functional areas of the application. From here, Users may choose to browse products, perform a makeup consultation or perform a skin care analysis session.

The menu items available are determined by whether or not the Agent is logged in or not.

For example, when the Agent is not logged the only the following options are available:
Product Browser
Manual Login
   However, when the Agent is logged in, the following additional options become available:
Consultation
Skin Care Analysis
Profile Management

### Product Browser

The application may provide the User with a way to browse products, product categories and related video content. A consistent browsing method provides the User with the means to navigate the content.

Product information is also displayed when one or more items with a specialized tag are placed on the Surface device.

Product Content Storage: The content (metadata and resources) may be stored locally on the device as per the Infusion. Content specifications in Appendix A.

### Customer Profiles

In some embodiments, customers may create profiles act as a marker for identifying data related to that customer and restrict access to that data as needed, for example, restricting access to the data to only the customer to whom the profile belongs and the goods/services provider.

In some embodiments, when an Agent is logged in, the application may allow them to find, create and view Customer profiles. They may be able to open the Customer's profile, view past consultations and skin care analysis sessions. They may also be able to start new consultations and new skin care analysis sessions.

Profiles may be keyed on the Customer's email address and may store the Customer's name, consultations and skin care analysis sessions. No secondary authentication mechanism is anticipated (e.g. password or PIN).

Basic Profile Information: The application may store Customer Name and Email Address as part of the basic profile information. If the Customer has previously participated in a skin-care analysis session, a thumbnail of one of the images may be used to identify the Customer visually.

In some embodiments, Customers may organize content related to their profile for easy access during future consultations or customer viewing. For example, saving images of clothing items that are planned to be worn together. In some embodiments, images may be moved and duplicated in various groups as desired. In some embodiments customers may upload data to the cloud or an interfacing device, for example, images or video saved on their mobile electronic device or personal computer. In some embodiments either the customer or the service provider may freely edit the data file names for easy recognition. A single data file may optionally be represented by different names for the customer and the service provider with the displayed file name being determined the person accessing the file. Alternatively, both file names may be displayed to either or both the customer and service provider.

Profile Storage: The profiles may be stored on the local device if there is a lack of centralized infrastructure and internet connectivity or in a cloud in access is available. The profiles may be stored in a SQL Server Express database.

### Makeup Consultation

The application may provide a collaborative way for customers and makeup artists to explore the effect of different available products. The process for a makeup consultation is as follows:
1) The consultant may initiate the consultation by placing their security tag on the device and choosing the consultation from the menu that appears.
   a) An alternative method for logging in may be provided (to address the case for lost security cards)
2) The consultant may be taken to the consultation screen where they may be presented with a simple drawing of the face. (a digital version of the current paper image) and a toolbox of different products. This drawing may be modified in real-time during the consultation in accordance with experience of the customer.
3) The makeup artist can either select a tool or place a product on the device. Once selected they can apply it to the outline. (e.g. select lipstick, and then touch the lips to have the colour of the lips changed to match)
   Note: The ability to choose a product instead of placing it on the Surface device acts as a fallback mechanism in case it is unavailable or a device without the ability to scan tags is used.
4) Once complete the customer may choose to save the consultation on the local device. They can do this by:
   a) Adding it to their existing profile
   b) Creating a new profile at the end of the consultation
      The customer may also:
View an exploded 3D view may be provided of the image and the individual product layers
View their own previously saved consultations on the device
Load a pre-set makeup consultation.

The consultation may also be shared and be made available to the customer away from the device via email, print out, mobile and/or the web.

Images and/or video may be taken during the consultation and replayed to the customer to show differences before, during various stages, and after the consultation. This data may optionally be paired with other data, for example, product information, comments/instructions from the Agent conducting the consultation, and/or the other forms data discussed herein. In the preferred embodiment, this information will be available live and in real-time to the customer. In some embodiments this data may be saved on the customer's mobile electronic device or in the cloud for latter access by the customer or service provider.

Consultation Storage: The data relating to a consultation may be stored in the local database or in the cloud and may include the following information:
Link to Customer Profile
Link to Agent who performed the consultation
Basic details such as date, time, location
Data captured from the makeup palette (including products used, locations, layers and other settings)

Any combination of the data generated or imported to a consultation may be simultaneously displayed during the consultation or upon review of the consultation on a mobile device or different interfacing device. The data being viewed may be optionally resized or hidden from display according to the preference of the customer and/or the Agent.

In addition to naming data files as desired, the data may also be marked to indicate a special status, for example, belonging to a particular group.

### Skin Care Analysis

The application may provide the ability to run a series of skin care analysis sessions by an analyst with a medical grade camera connected to the Surface device.

The process for the analysis is as follows:
1) If not logged in the analyst places their security tag on the Surface device.
   a) An alternative method for logging in may be provided (to address the case for lost security cards).
2) The analyst either chooses the Customer from a set of profiles on the Surface device or registers a new profile for the Customer.
3) The analyst chooses the Skin Care Analysis menu option.
4) The analyst takes a photograph of the Customer then transfers it to the Surface device.
5) The analyst and the Customer can now interactively:
   a) Explore a single image by panning, zooming and rotating.
   b) Compare two images taken at different times side by side.
   c) Watch a time-lapse view of the images taken over multiple sessions.
6) All images are saved for comparison during future sessions.

Skin Care Analysis Storage: The data relating to a skin care analysis session may be stored in the local database and may include the following information:
Link to Customer Profile.
Link to Agent who performed the consultation.
Basic details such as date, time, location.
Data captured from the medical imaging camera (image data, flexible metadata)

### Usage Metrics

Significant events in the application may be logged in a metrics store, allowing for future review and reporting. These metrics relate solely to how the application is used and are separate from the analysis of the data gathered from the database of User profiles. A sample of suggested metrics is included below:

| Metric Name | Description |
|---|---|
| Application Run Time | Duration that the application has |
| | been running for. |
| Application Idle Time | Duration that the application has been |
| | executing an idle loop without |
| | User interaction. |
| # of sessions | The number of unique User sessions |
| | (# of times exited from attract mode). |
| Product Views | The number of times a specific |
| | product has been viewed. Content can |
| | be a product, category or video. |
| Product View Time | The duration a specific product item |
| | has been viewed for. |
| Skin care analysis consultation | The number of times a skin care |
| sessions | analysis session has occurred. |
| Skin care analysis consultation | The duration of a skin care analysis |
| time | session. |
| Makeup consultation sessions | The number of times a makeup |
| | consultation has occurred |
| | (anonymous or Customer). |
| Makeup consultation time | The duration of a makeup consultation |
| | session. |
| # of Agent logins | The number of times an Agent has |
| | logged into the system. |
| Duration of Agent login | The time spent with an Agent logged |
| | into the system. |

All metrics may be available in raw form on the device itself.

### Logging

Logging may be implemented throughout the application to provide debugging and low level information on the operation of the Surface application. This is invaluable in tracking and resolving any issues with the Surface application.

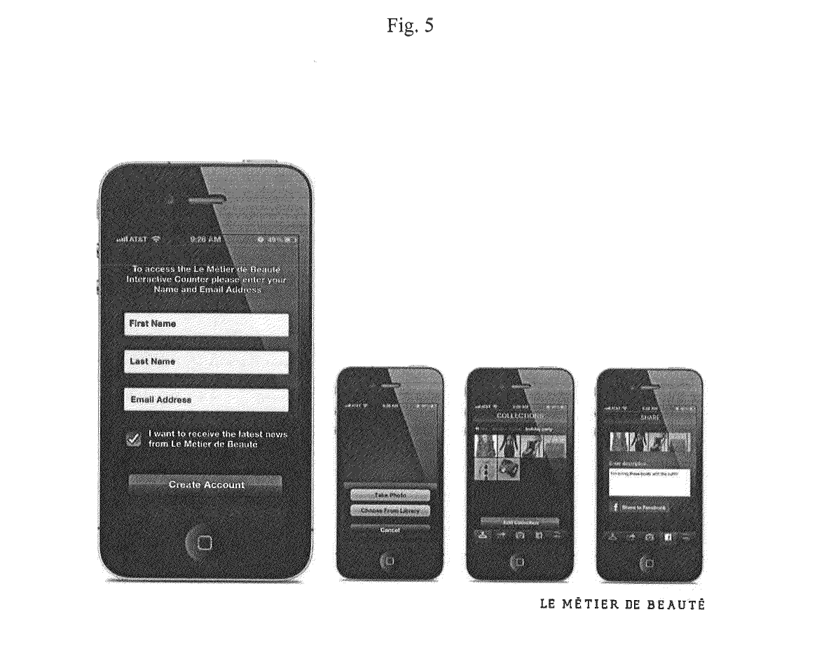

FIG. 5 shows an overview of the mobile application in some embodiments of the system including, for example, the screen for creating an account, creating and editing collections, and uploading data to third parties. In the preferred embodiments, when a User interfaces with the system for the first time, he or she is prompted to create a new account. In the preferred embodiments, the User will have the option to upload data, for example images or video data into collections which may additionally comprise data from consultations. The User will also have option of editing and manipulating the data in the collections which will be described in greater detail below. In the preferred embodiments, the User may share any data from the collections with a third party, for example, FACEBOOK.

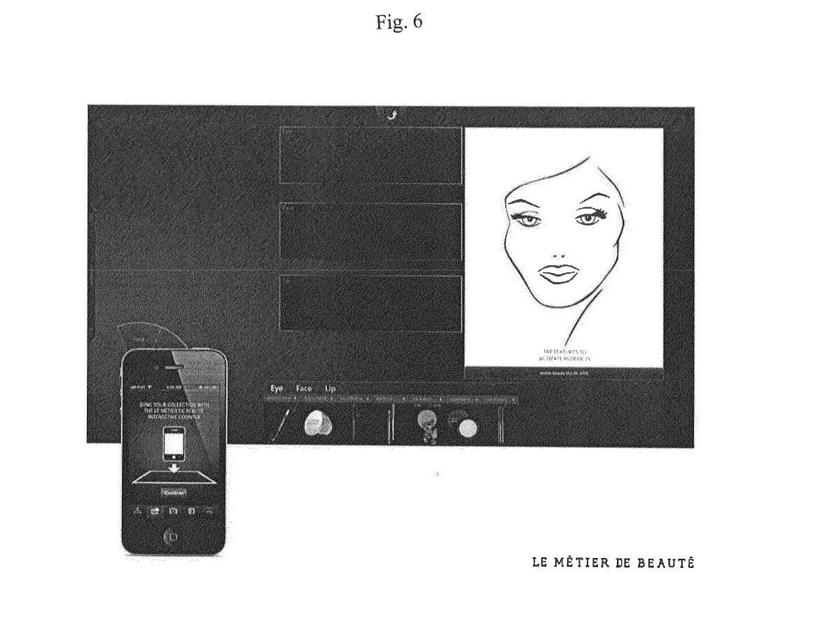

FIG. 6 shows a mobile electronic device syncing with a digital counter in some embodiments of the system. In some embodiments, synching is accomplished by placing the phone down and detecting that accelerometer change and the blob generated by the phone. This is not successful in all embodiments, for example, the HP touchsmart has difficulty detecting the phone blob, but could detect the hand holding the phone and the action of pressing against a surface. Many mobile electronic devices are also capable of detecting a User swinging the device downwards through the use of a built in accelerometer (bump) which will send that device to the sync service. If the service detected a bump both on the Digital Counter and the mobile electronic device within an acceptable range of time it would pair up those two devices in a session.

In other embodiments, button taps on each of the devices are used instead of bumping them. For example the Users of the mobile electronic device and digital counter each tap a sync button at a similar time and place which allows the deices to sync. This is to prevent the Users from damaging their mobile electronic devices and the digital counter when they bumped them and acts as an alternative to Users with mobile electronic device incapable of bump syncing.

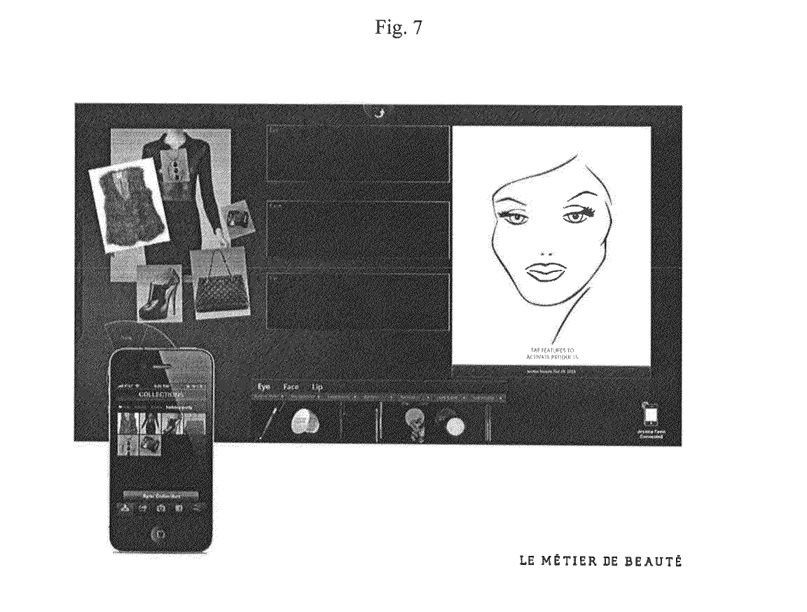

FIG. 7 shows data being transferred from the mobile electronic device to the system in some embodiments of the system. In the embodiment shown in FIG. 7, image data from the customer's cell phone has been transferred to the digital counter for use in a consultation. The figure also show the images arranged as desired by the User, for example, to simulate an outfit using all the items in the images.

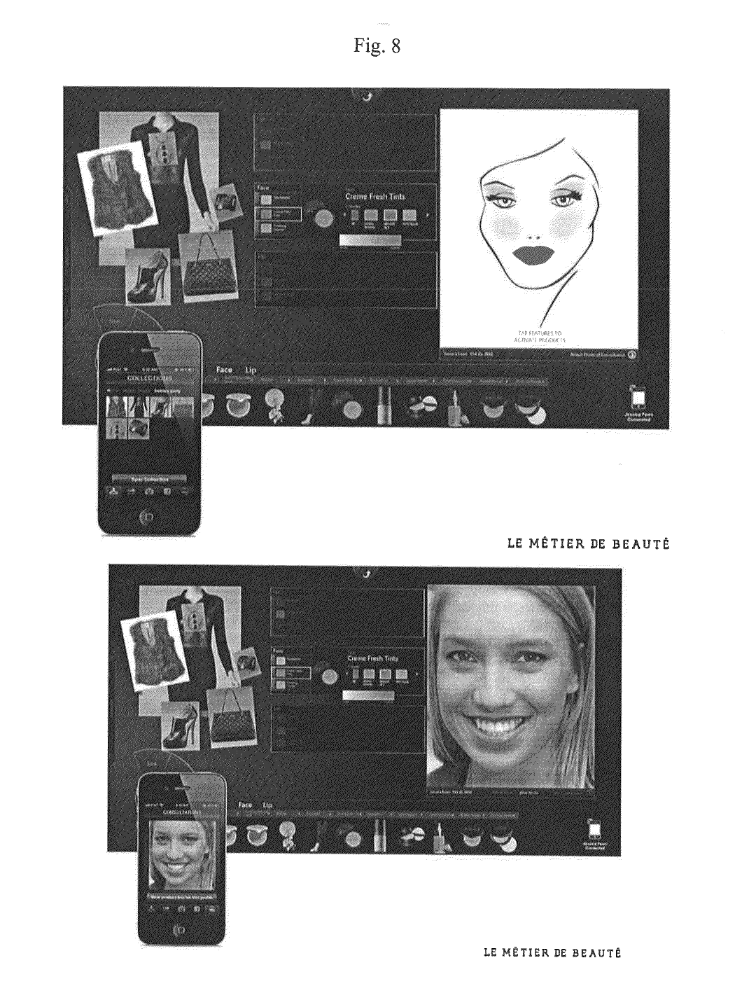

FIG. 8 illustrates a consultation in progress in some embodiments of the system. The interface shows the products used during the consultation in the order that they were used. In the preferred embodiment the service provider may also include notes or other data. In some embodiments a line drawn face highlighting the products used in the consultation may be displayed. In some embodiments, each area of face (Eye, Complexion, Lip) will be selectable to see an exploded view displaying color layering. In some embodiments, images of the customers face at various stages of the consultation may be displayed, for example, before the consultation and after the consultation has been completed.

In some embodiments, video is recorded during the consultation. In some embodiments the video data taken during the consultation is marked every time a new product is used and is optionally linked with that product enabling video playback of the linked event when the product is selected during the consultation or upon latter viewing by the customer. The video may also be linked to comments created by the service provider during the consultation. These comments will optionally appear when the portion of the video to which they have been linked is played. In some embodiments the video recording can be stopped and started as desired during the consultation to prevent excessive periods of non-active or repetitive material in the video. In some embodiments, the line drawing and customer image/video date can be toggled between or displayed simultaneously.

The data related to the products can vary based on the database used, but in the preferred embodiment, products are organized into groups, for example, brand and product type. When a particular group is selected during a consultation all the products of the group are displayed. In the preferred embodiment, the product screens can include any combination of the following:
1) Family which it is associated with if applicable
2) Product Image
3) Product Copy
4) Technology if applicable
5) Directions of Use
6) Shades
7) Size/Weight
8) SRP
9) Application Video
10) Tool Tip Video
11) Related Products—Could be up to 3 associated products to build bundle

FIG. 8 specifically shows a face makeup group where various shades and colors of the group can be selected in some embodiments of the system. Once selected the line drawn face display shows the effect of the added product and a new video marking is optionally added. Also, in the preferred embodiment, the product is included in the list of products used and in the order that it was used which is optionally displayed and the bottom of the interface display. Any combination of the information shown in the figure may be displayed during the consultation or viewed at a later date. In the preferred embodiment, when multiple products are placed on the unit within close proximity, total price of products will be calculated and optionally displayed. In some embodiments, if a promotion is running and the selected products qualify, a visual prompt will be displayed alerting customer that they qualify for promotion (GWP). This will be calculated real-time so Users and add and subtract to create their own product bundles and allow them to explore added value.

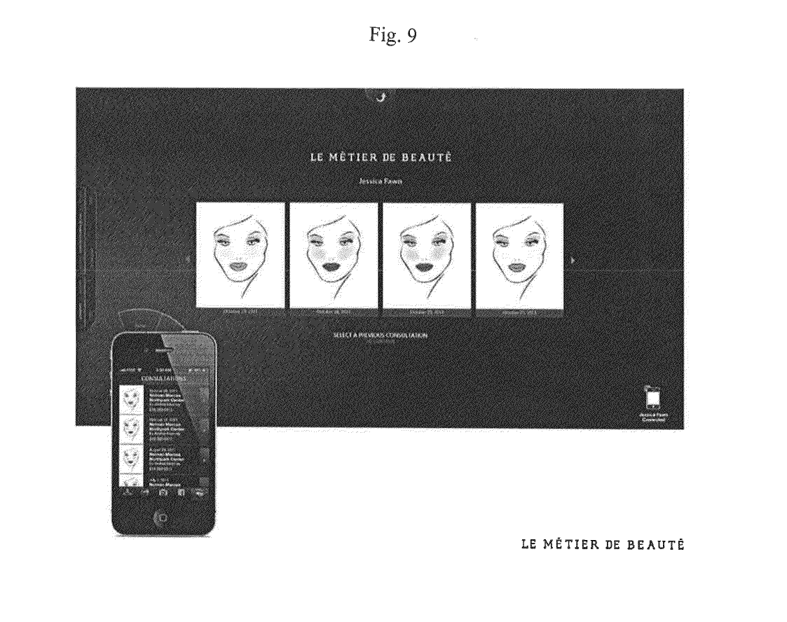

FIG. 9 shows a consultation history display in some embodiments of the system. The consultation history shows a collective history of all the consultations undertaken by a particular customer. In the preferred embodiment, each consultation is visually represented by the final face line drawings of the consultation it represents. In the preferred embodiment, the date the consultation took place is also displayed. By selecting one of the consultations the data created during that consultation is available to the User.

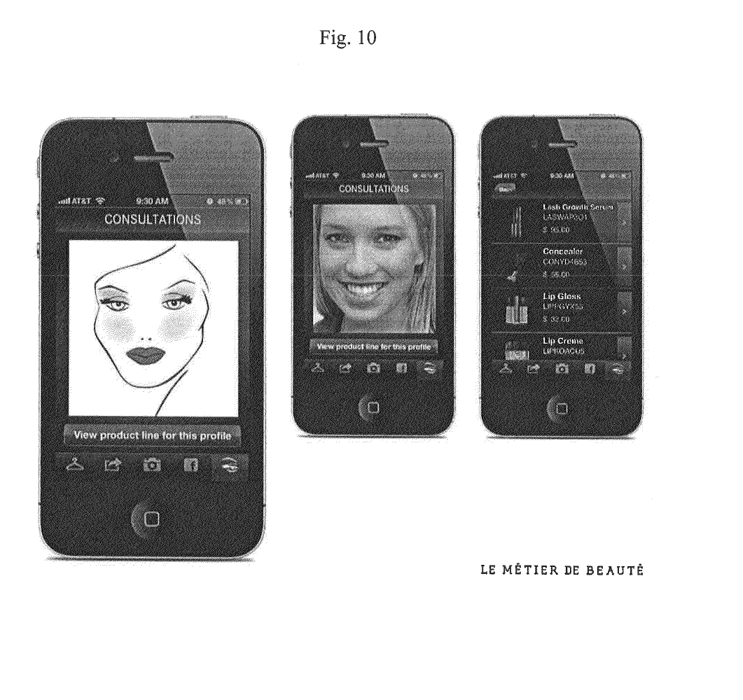

FIG. 10 shows various displays of the mobile application in some embodiments of the system. In the preferred embodiment, customers will have access to any and all information produced during a consultation, for example, the line drawn face display showing application of the products used, an image or video of the customer at various stages of the consultation, and a listing of products in the order that were used with information such as name and price displayed with the products.

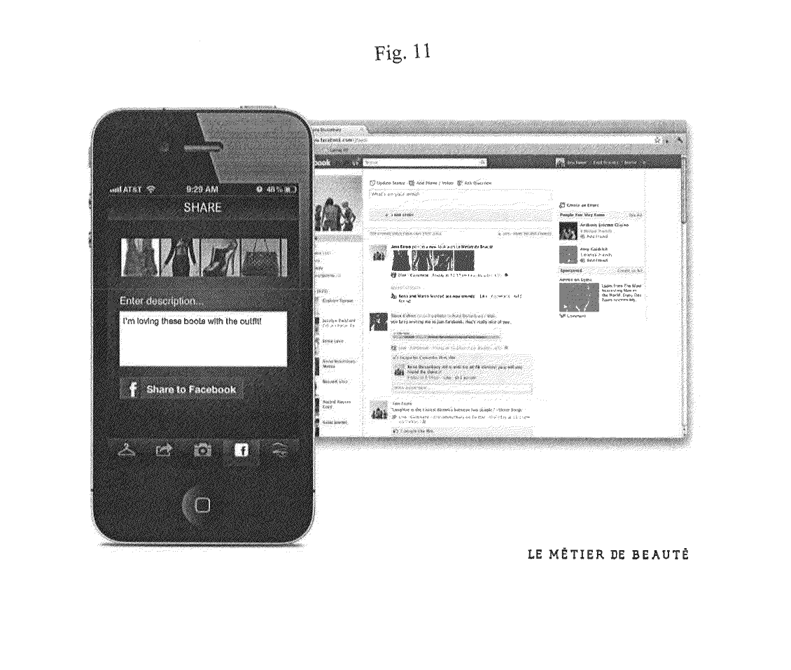

FIG. 11 shows a mobile electronic device syncing with a third party website. In the preferred embodiment, data during a consultation can be uploaded to a social media website, for example, FACEBOOK and displayed on the third party platform, for example, a FACEBOOK page. In some embodiments, the User may also attach text data to the data from the consultation data to be displayed on the third party platform.

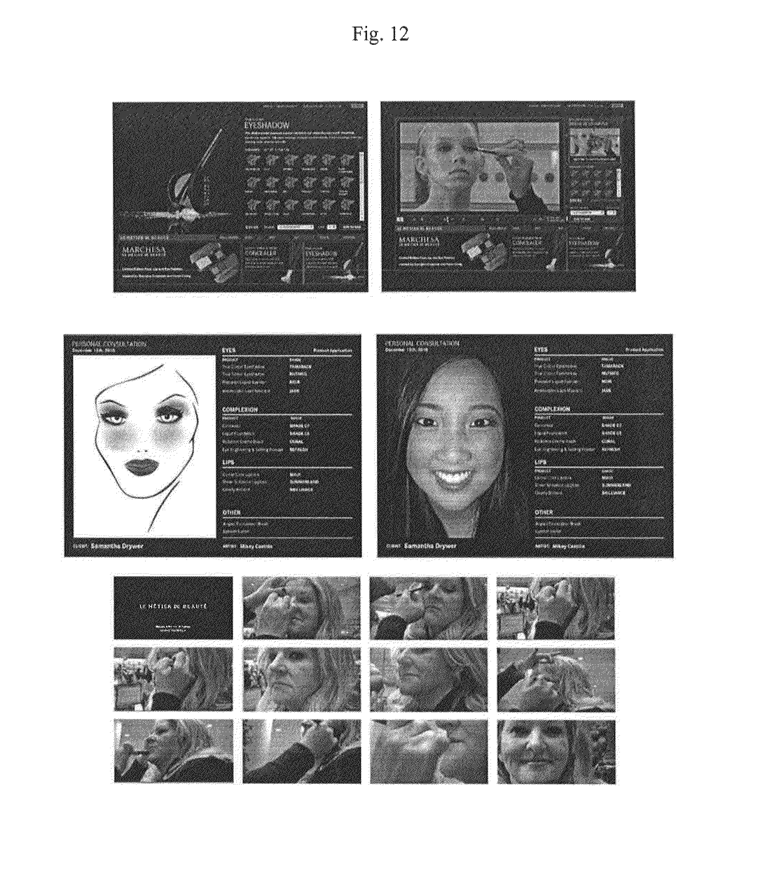

FIG. 12 shows various examples of consultation interface in some embodiments of the system. The figure show various screen shots of consultation that can be displayed at the time of the consultation or reviewed at a later date.

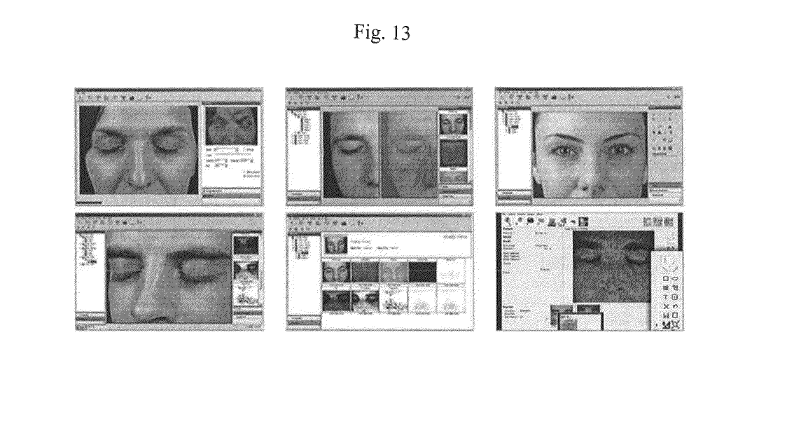

FIG. 13 shows various screen shots of the skin care analysis feature in some embodiments of the system. The requirements of the skin care camera must be matched to the capabilities of the application programming interface (API). In the preferred embodiment, the API itself is wrapped using a typical .Net provider pattern and is abstracted from the rest of the application. Synching the patient in the skin care service and the customer is done simply by pairing up the patient identifier with the local Customer identifier. This association is made by the goods or services provider via a User interface in which they find the patient in the skin care system for the current Customer and match the two.

The skin care consultation component can also be used to compare any two or more images over a period of time. This can easily be adapted to any application where a visualization of change over time is desired.

In the preferred embodiment, data in the system relates to beauty products. The product browser and attract loop components of the digital counter are capable of presenting and showcasing any other range of products. Data relating to for example, sporting equipment, clothes, toys, electronics, automotive parts, or furniture can be processed and displayed by the system.

In some embodiments, a print out is provided at the counter which can be given to customer at the end of the consultation with list of products used, steps and color chart/finished look image.

In some embodiments, live video feed is available on unit to align customer into proper position. Once aligned service provider, for example, a dermatologist/Makeup Artist (MUA) will take skincare images. Four images are taken daylight, polarized, cross polarized infrared and UV.

Pigmentaion and Vascular conditions are automated via image processing of blood concentration, red and brown concentration analysis by software.

Analysis of skin elasticity and texture is subjective and can be performed by trained individuals.

Quantitive and Visual Assessment of Ultraviolet data indicating acne, solar damage, melasma and dehydration may be captured.

Within Profect Medicals software there is functionality to measure skin lesions, scar tissue and wrinkle length.

The disclosed embodiments provide the ability to cross reference previous images to current image, side by side comparison. Images can be zoomed into to deliver closer detail. Both images scroll, zoom simultaneously.

Once a User has multiple images stored into database, timelapse animation can be delivered giving User true reference to demonstrate clinical improvement and progression of existing conditions.

Info graphics give customer visual data of skin analysis and progression. The preferred embodiments can give comparative data to pool of participants. (ie, Your skin ranks 85% better than others in your age group.)

Visual data can be delivered to provide real time progression as timelapse is being viewed (ie, Skin age decreases as images cycle through animation).

Dermatologists can mark areas of interest and place notes within system for future reference.

Skincare regimen is built based on analysis data and skin interests or concerns. Regimen includes recommended application techniques by dermatologist.

Analysis and regimen is pushed to customers account via email address.

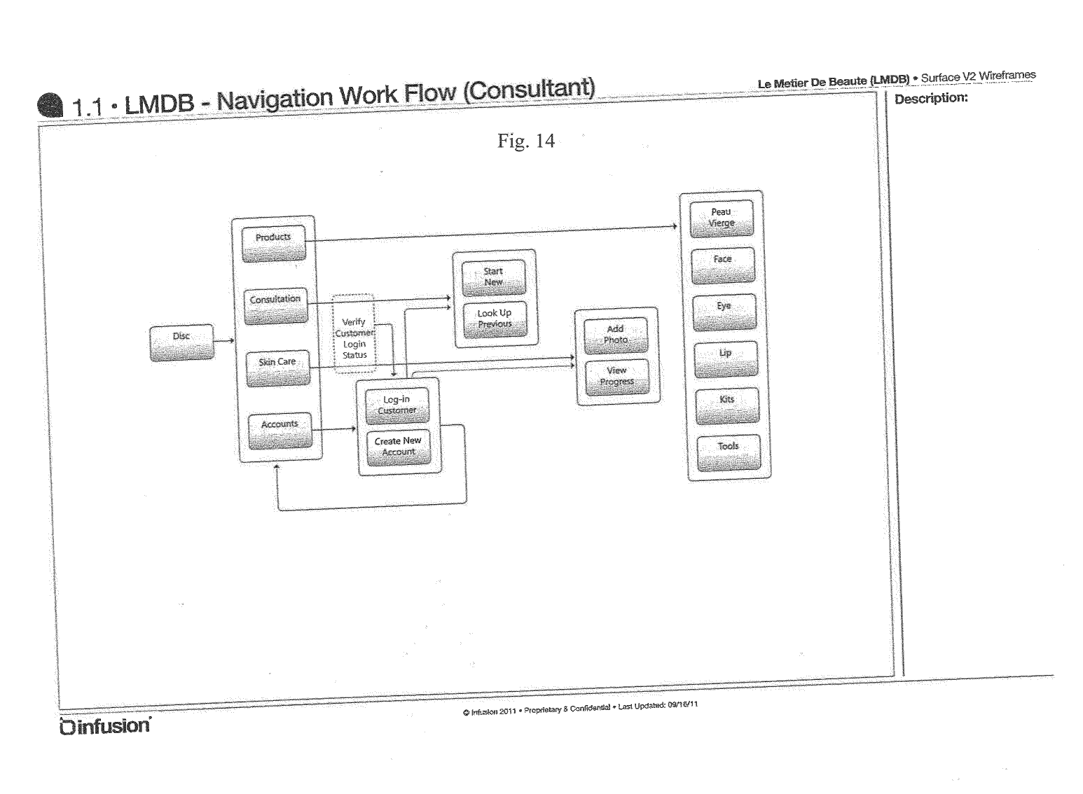

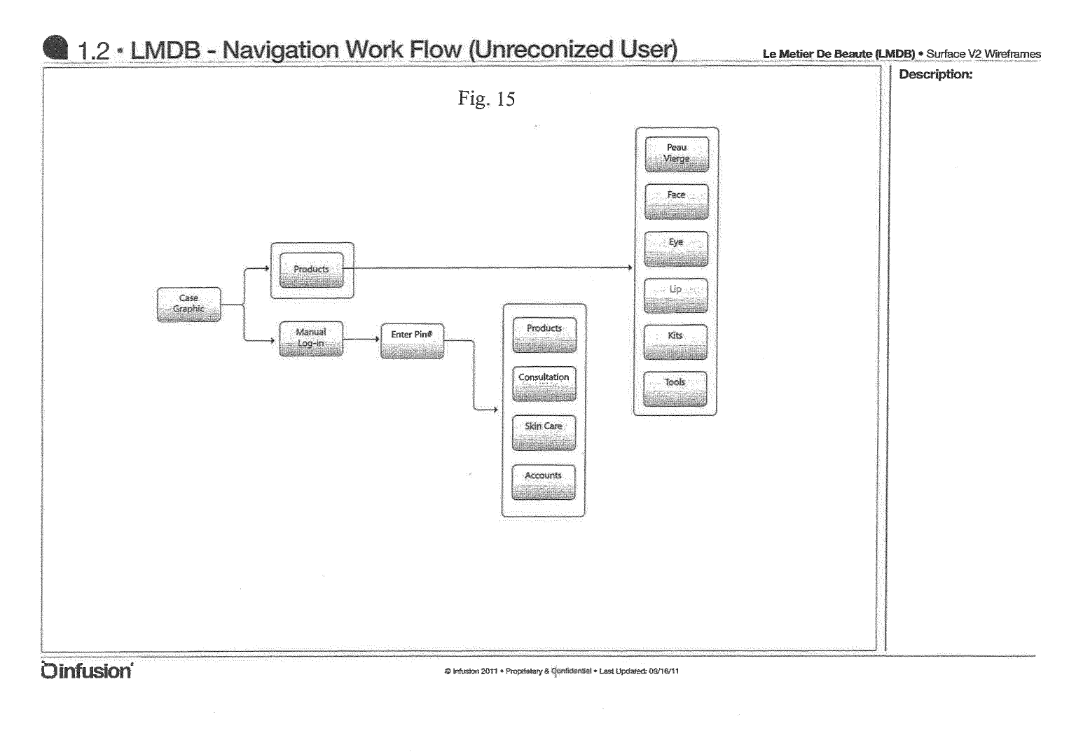

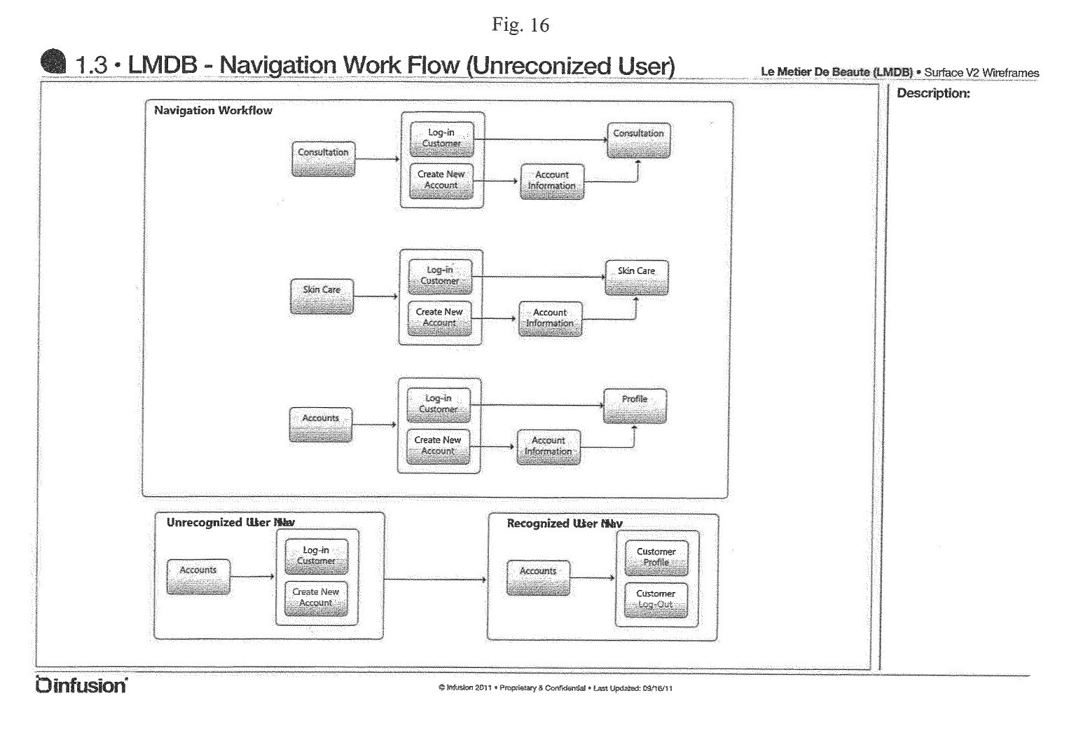

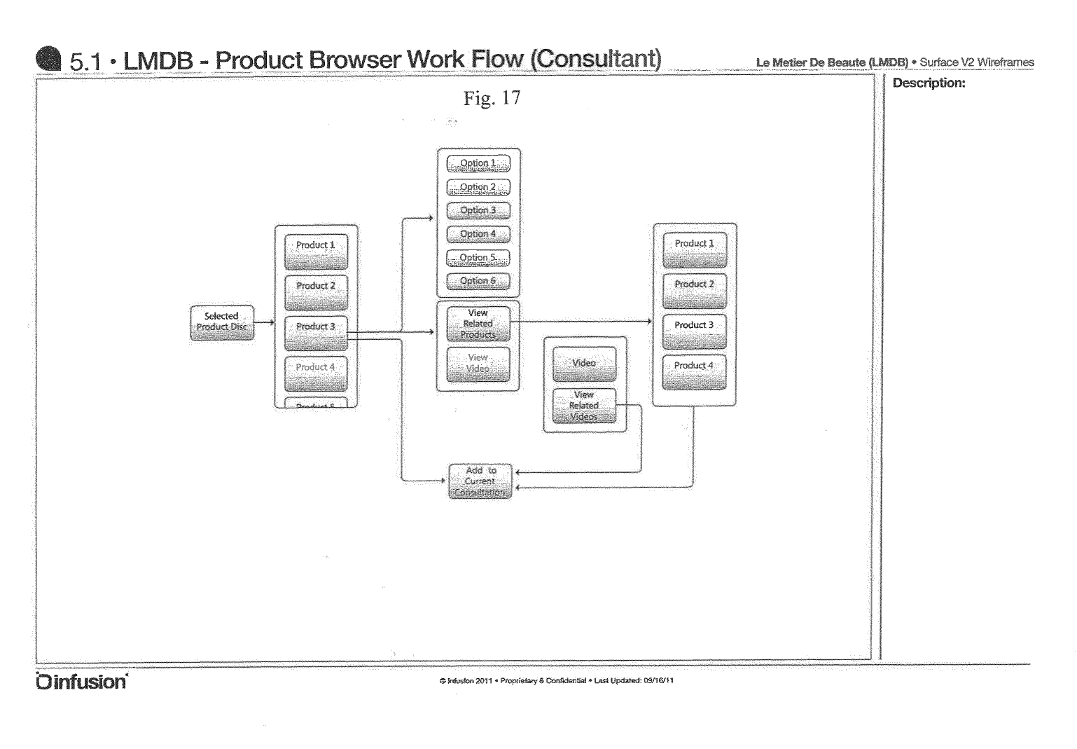

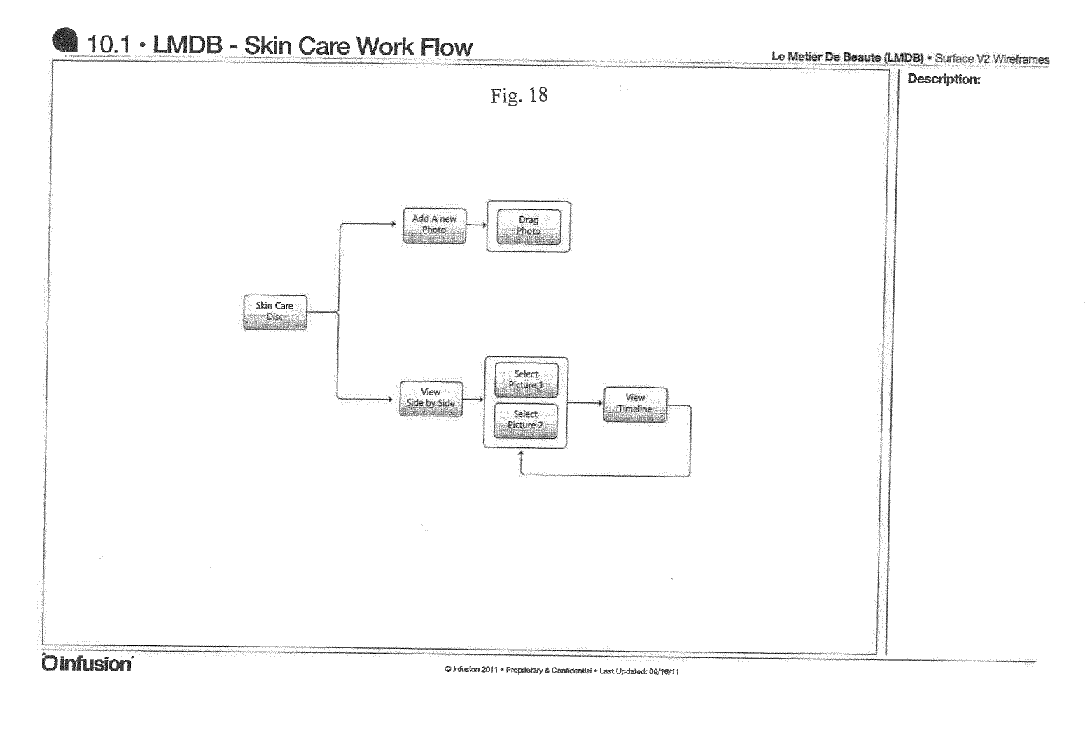

FIGS. 14-18 show various workflow processes of some of the embodiments of the system.

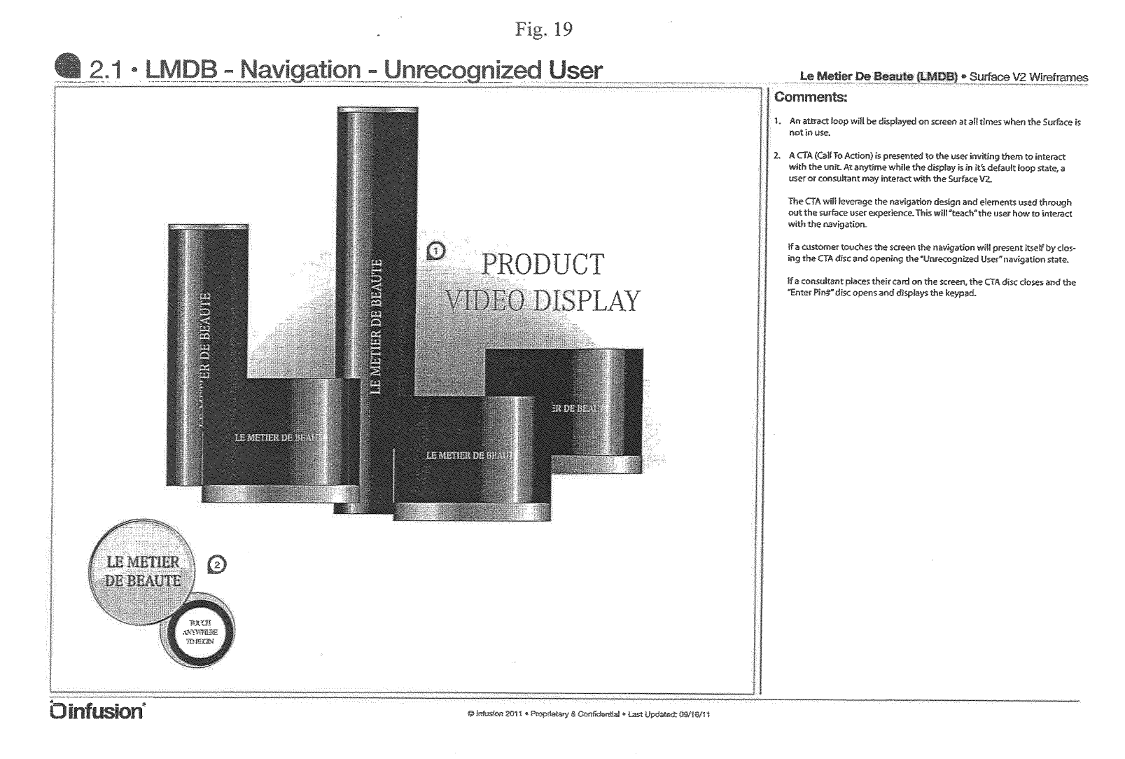

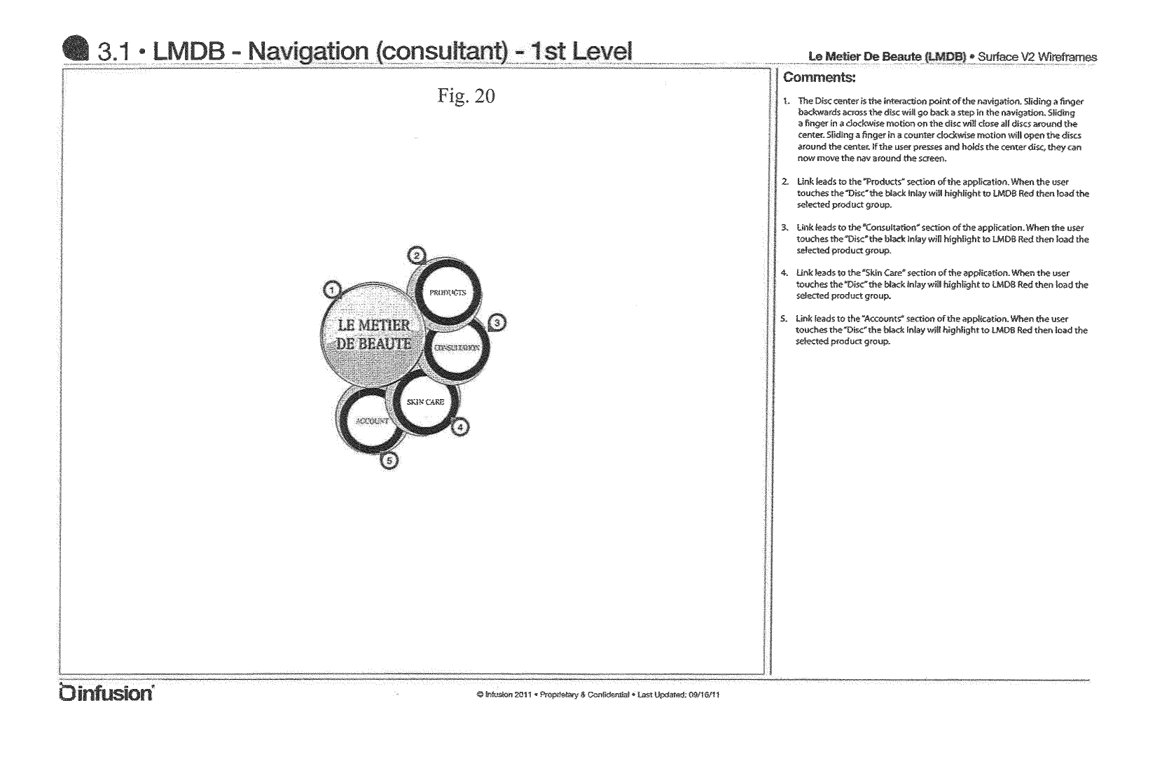

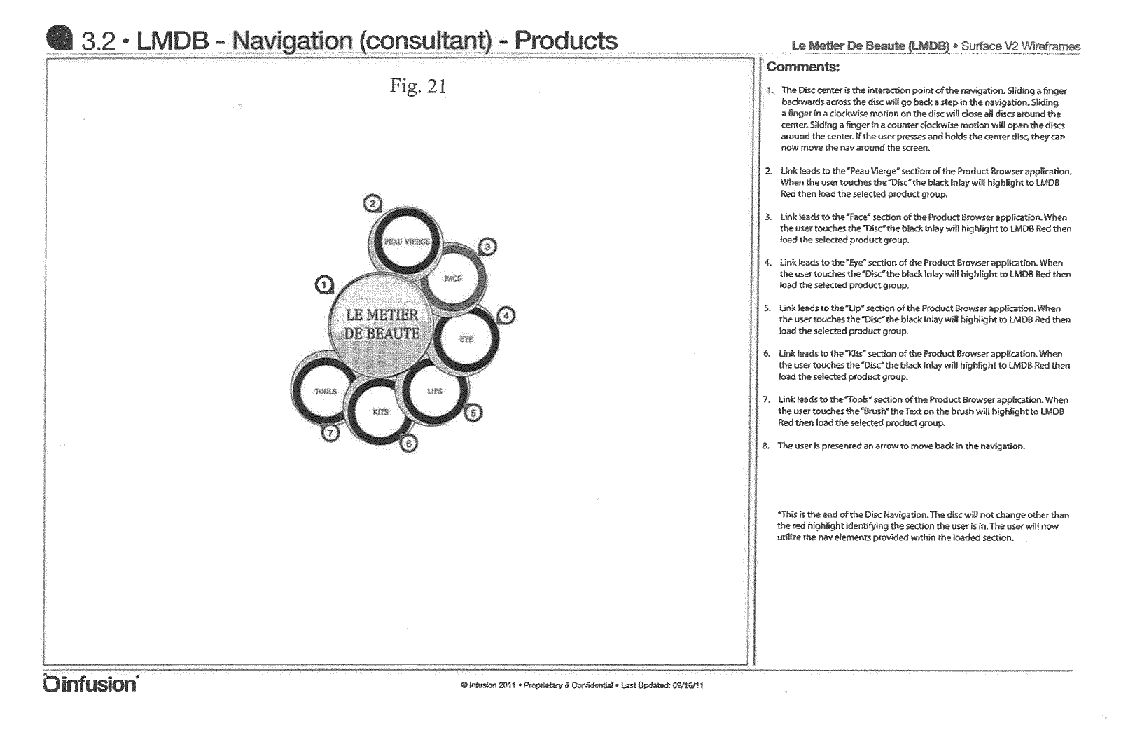

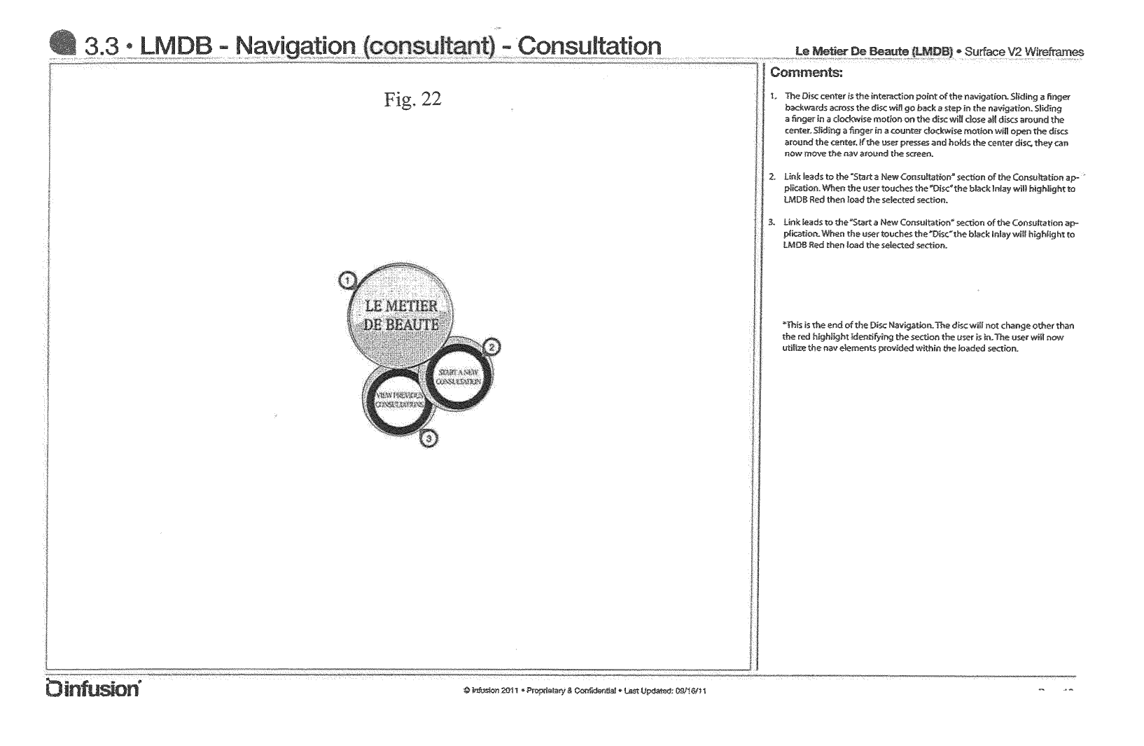

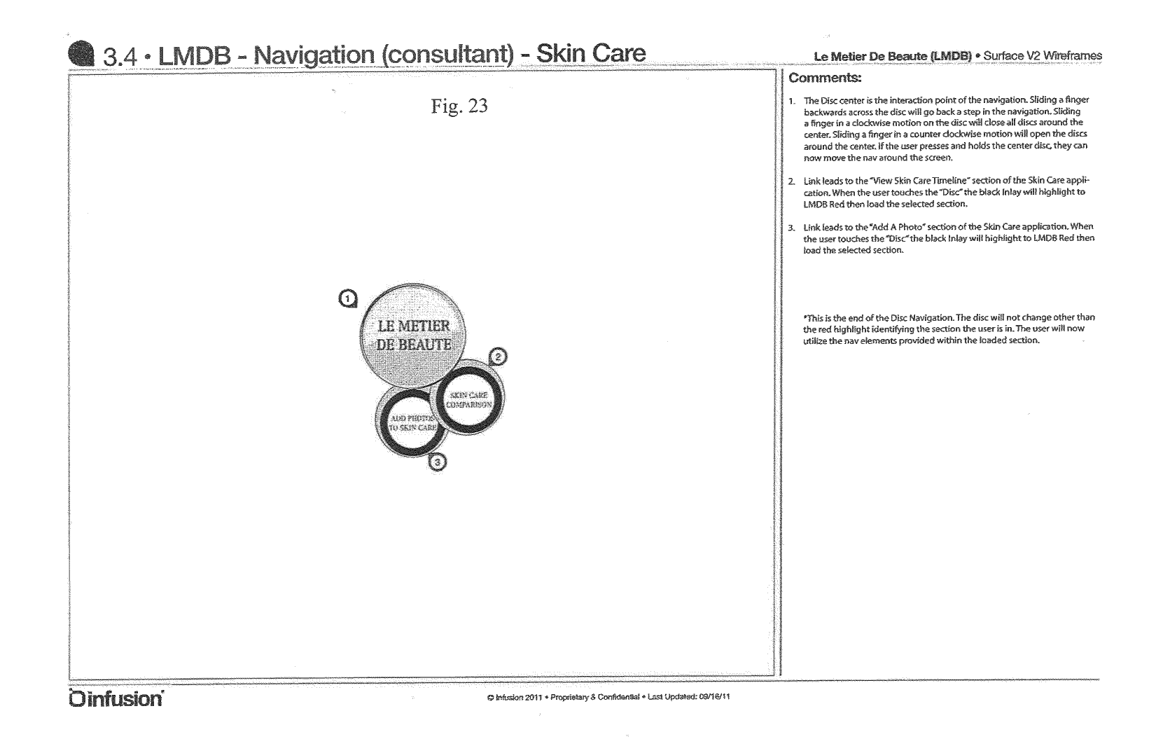

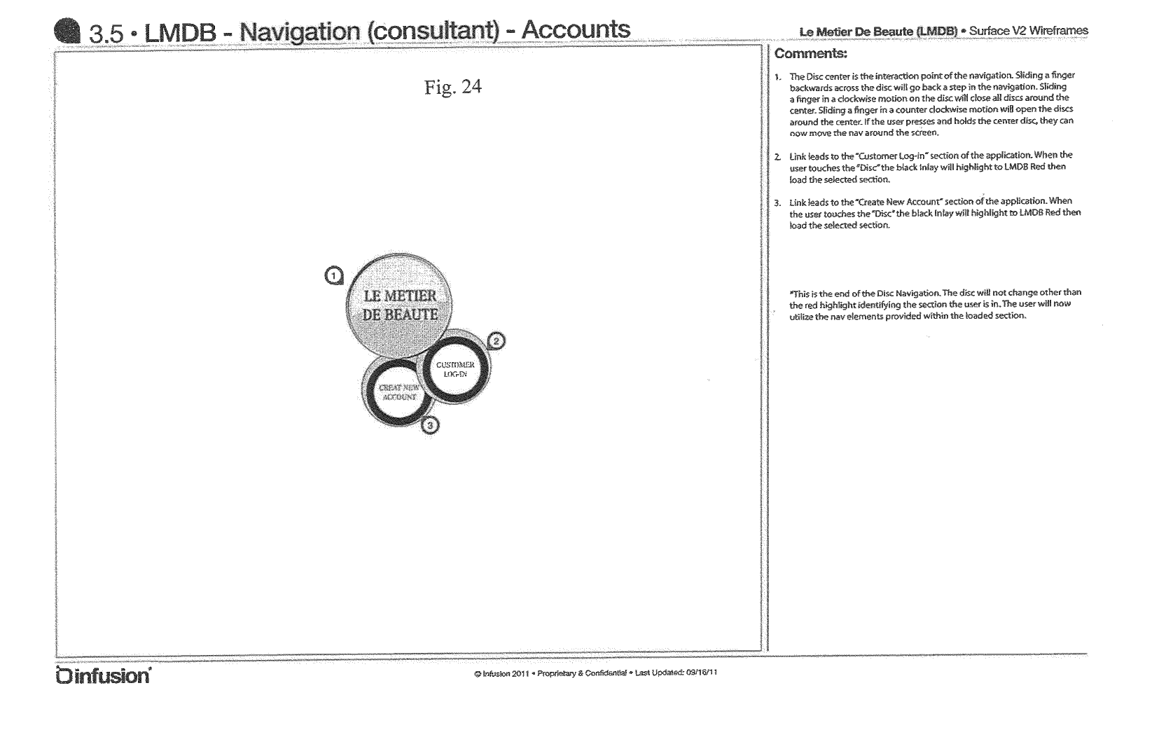

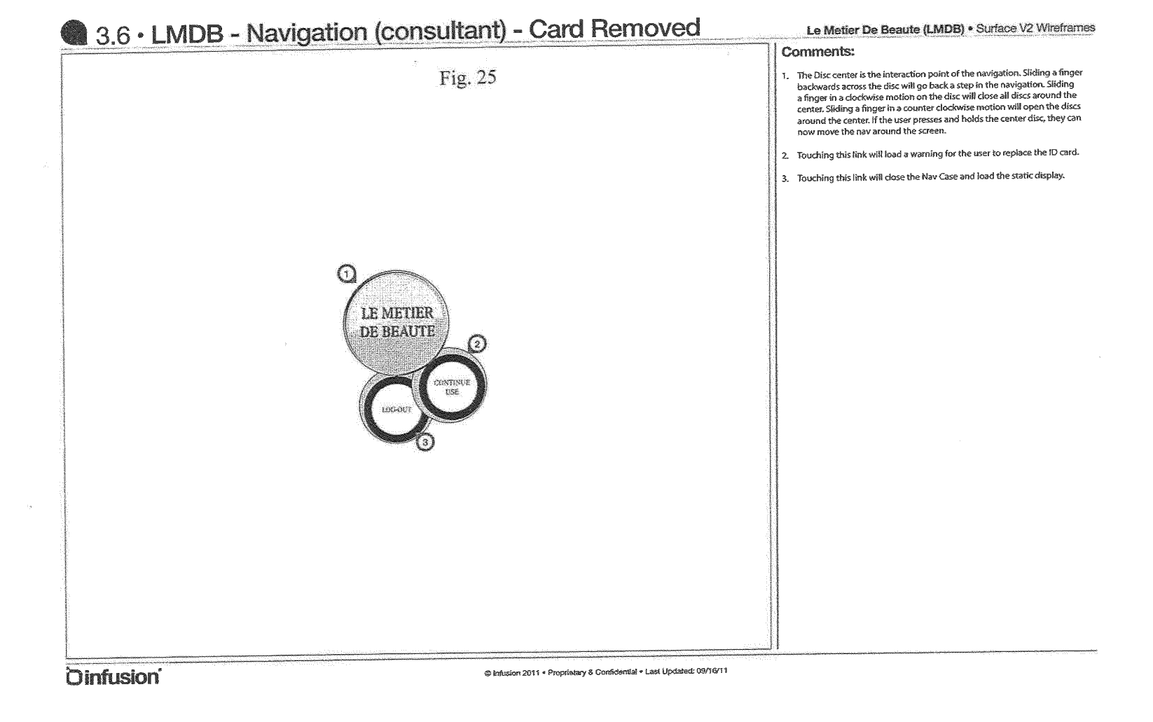

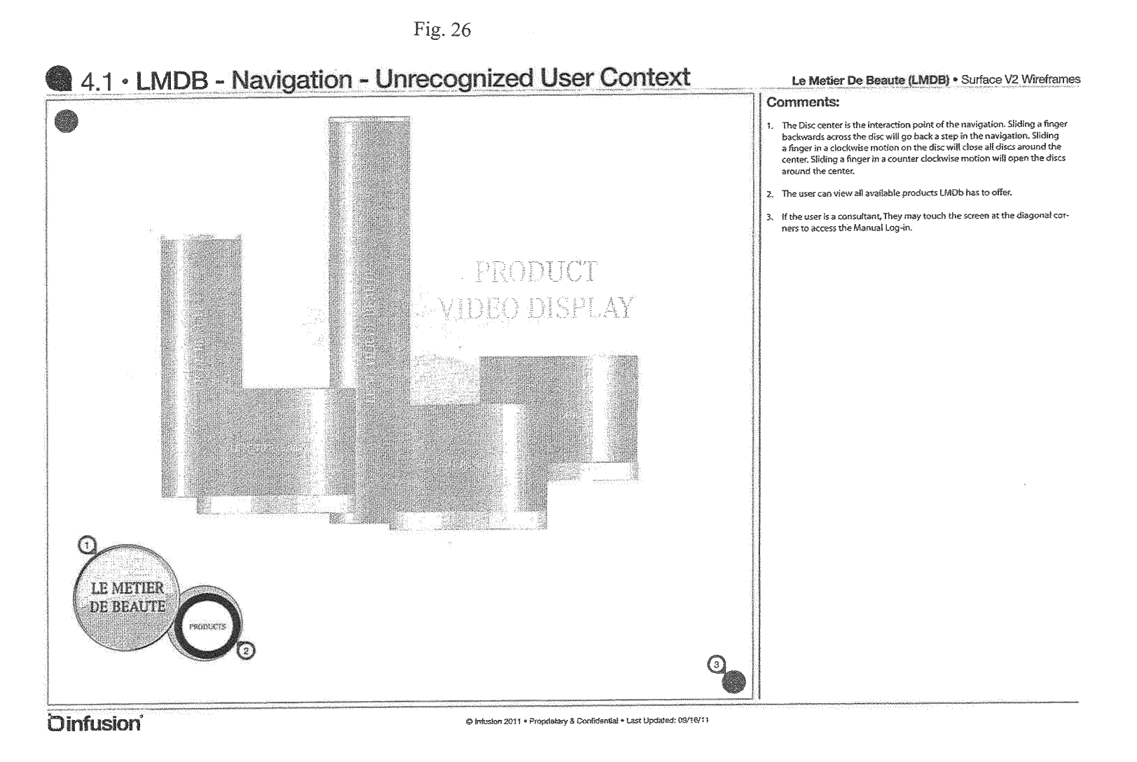

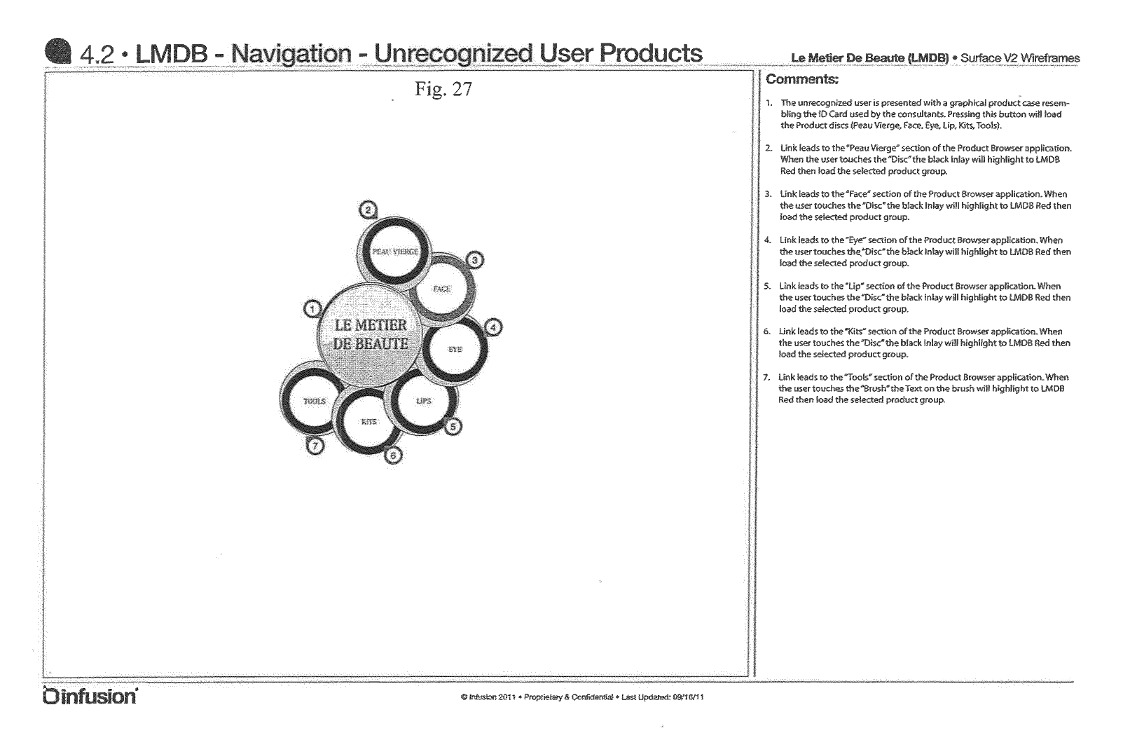

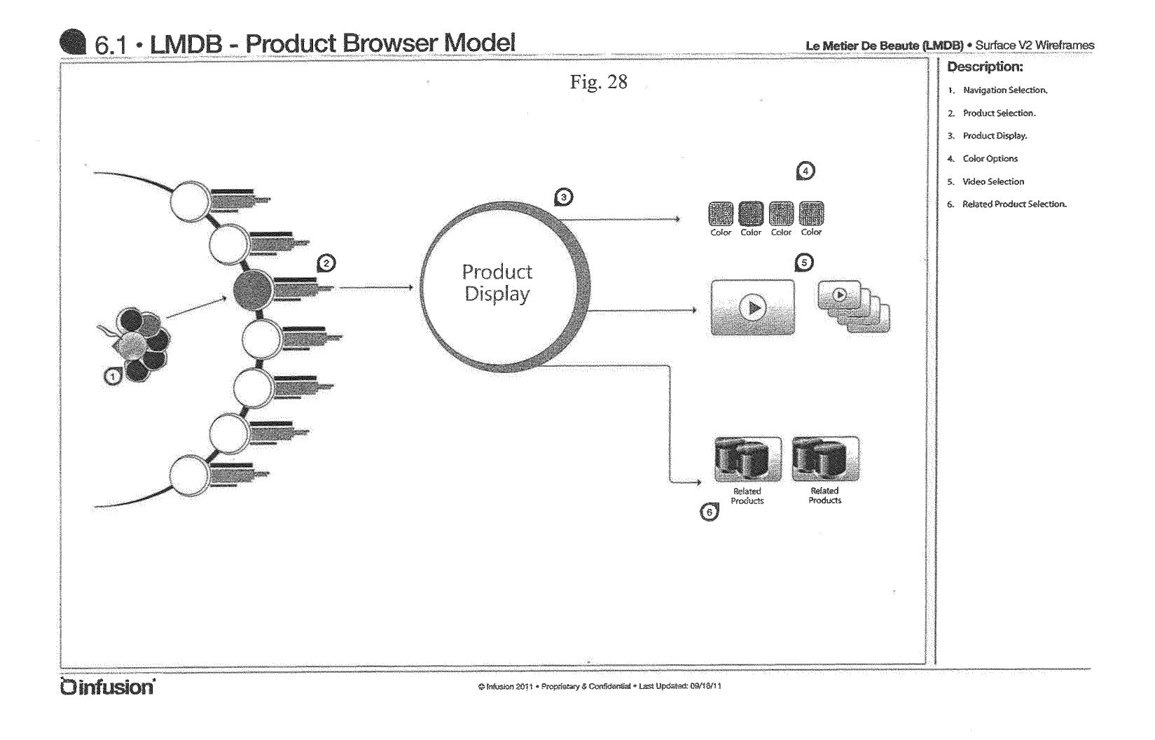

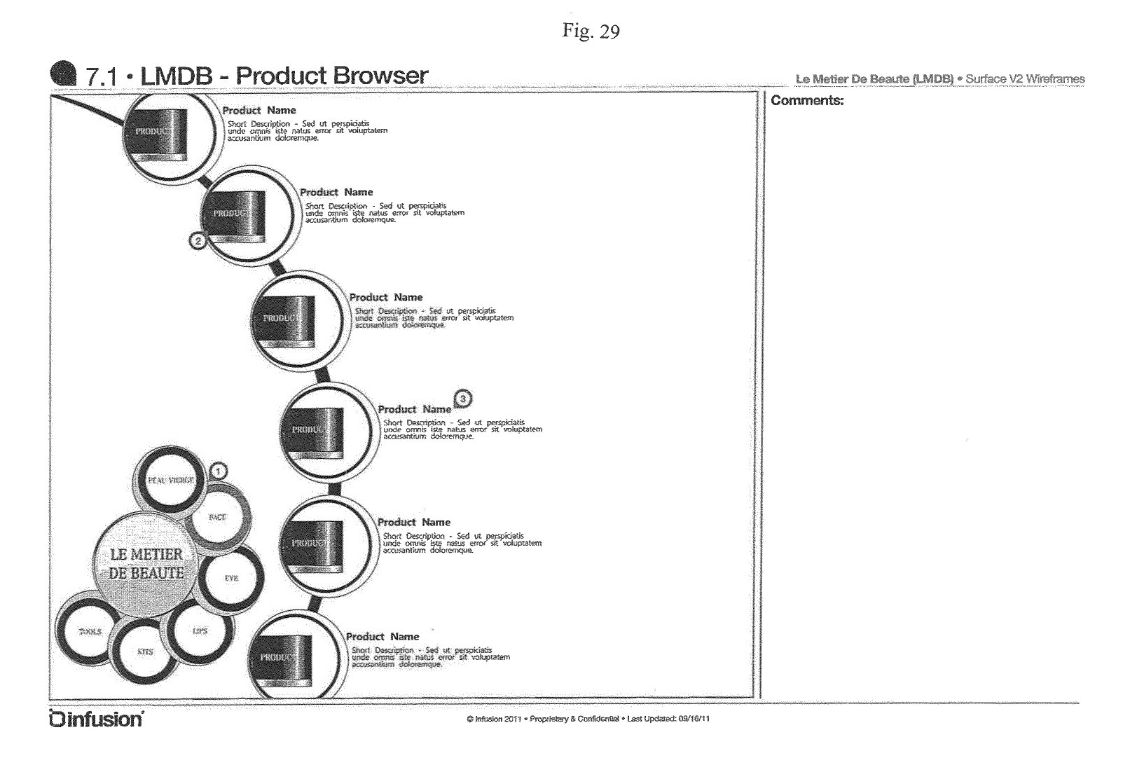

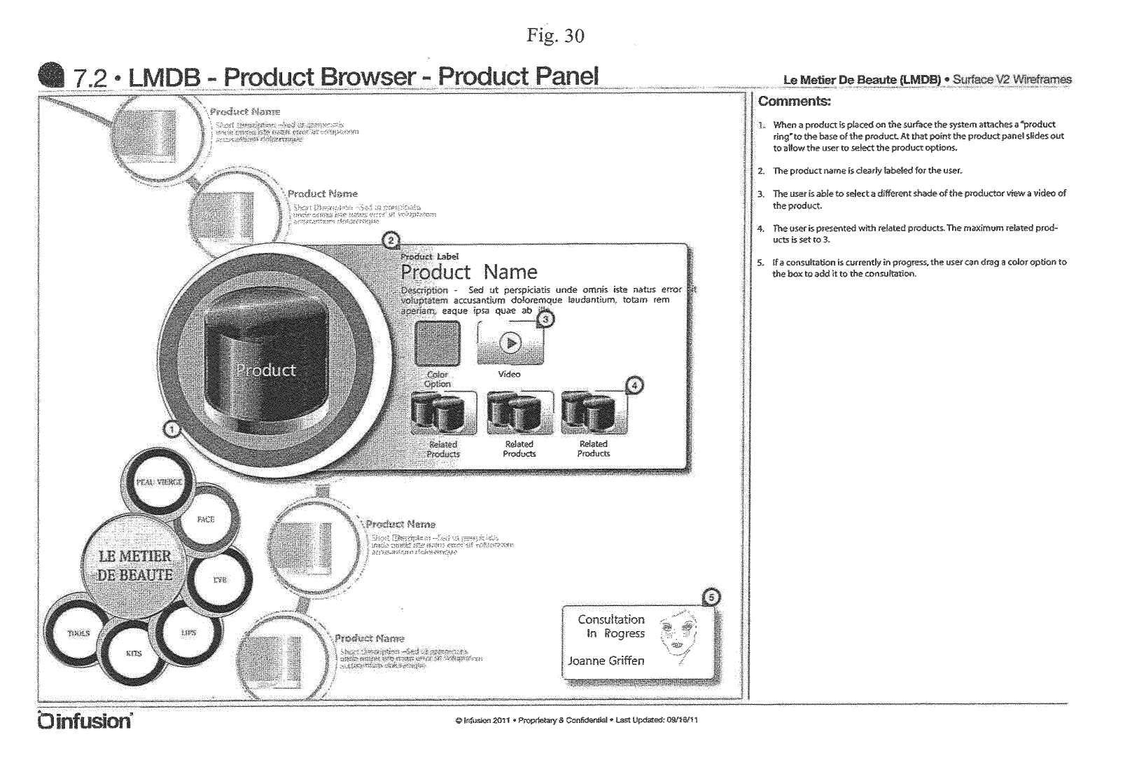

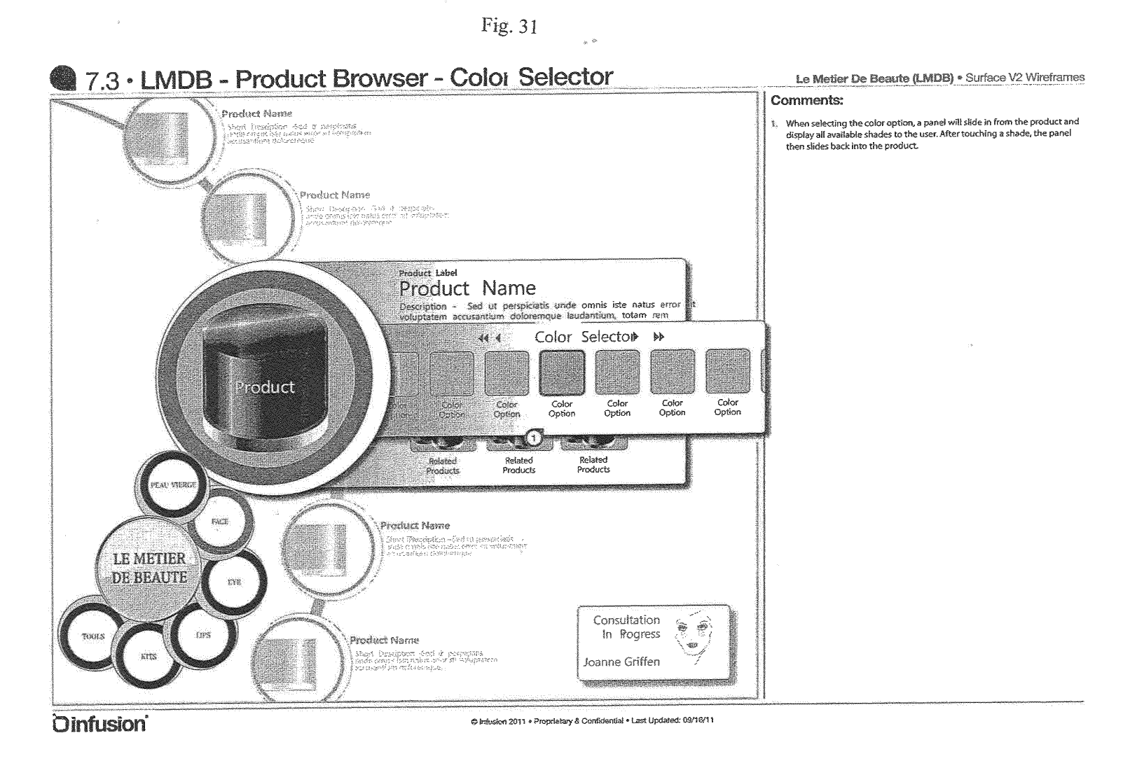

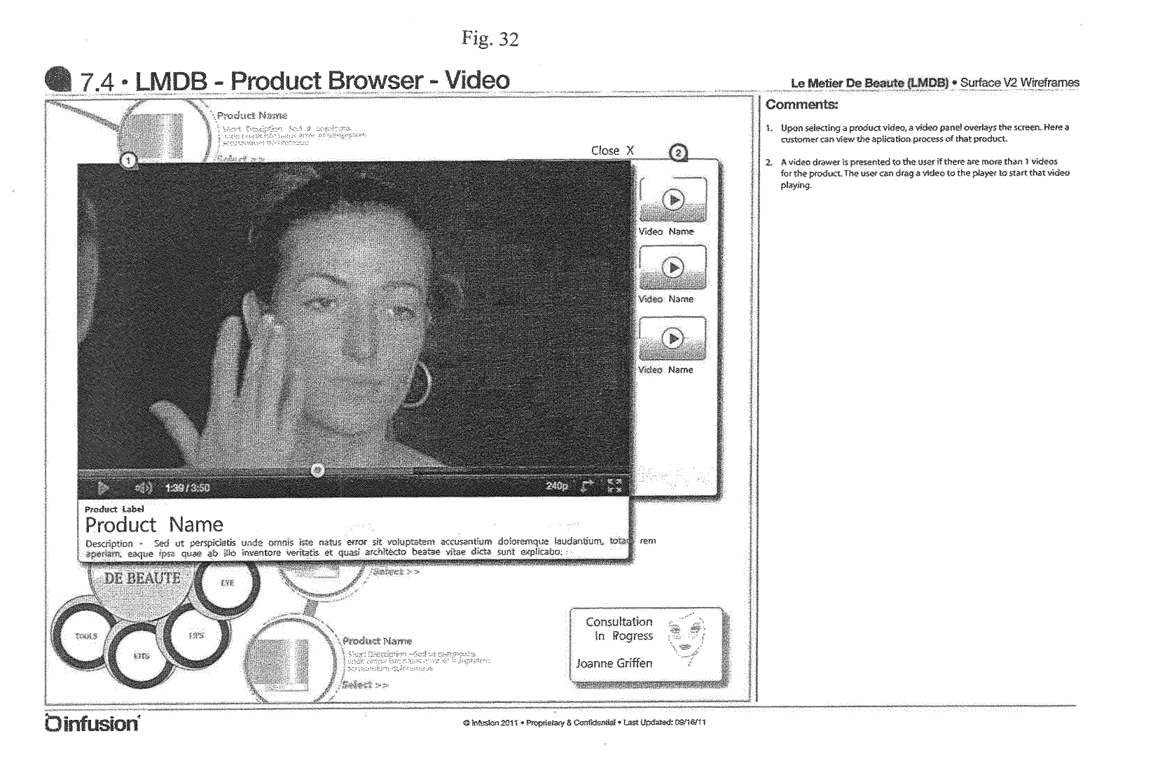

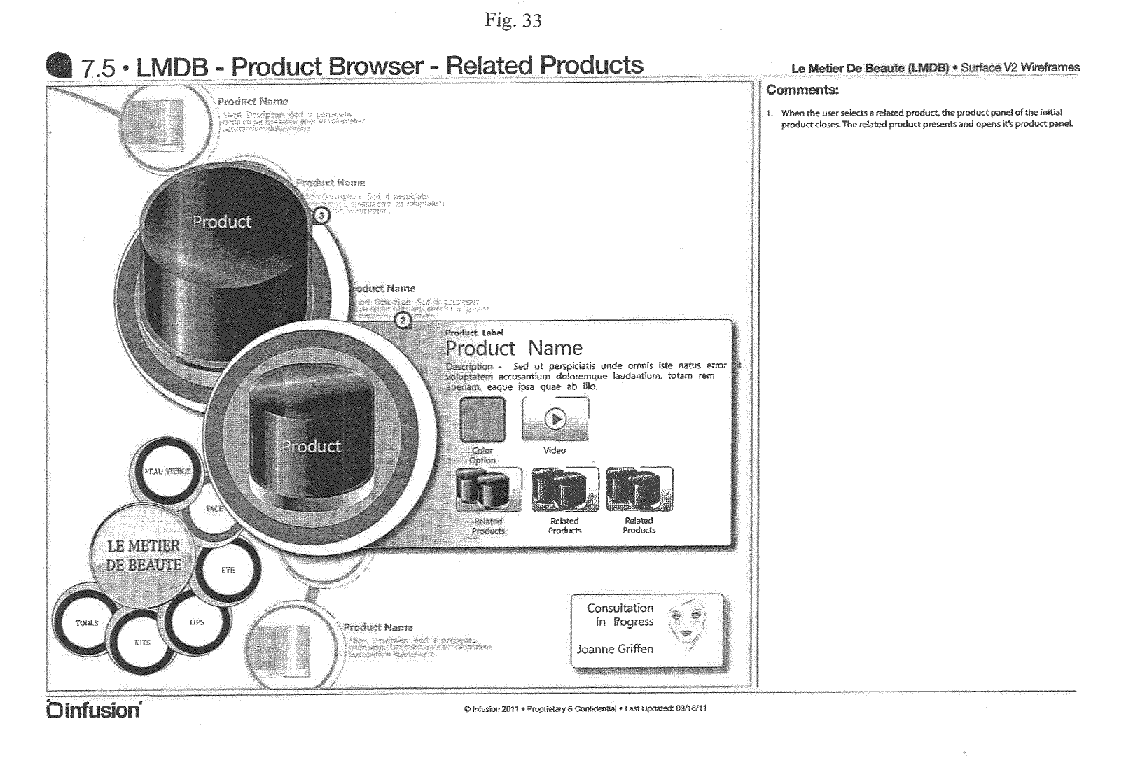

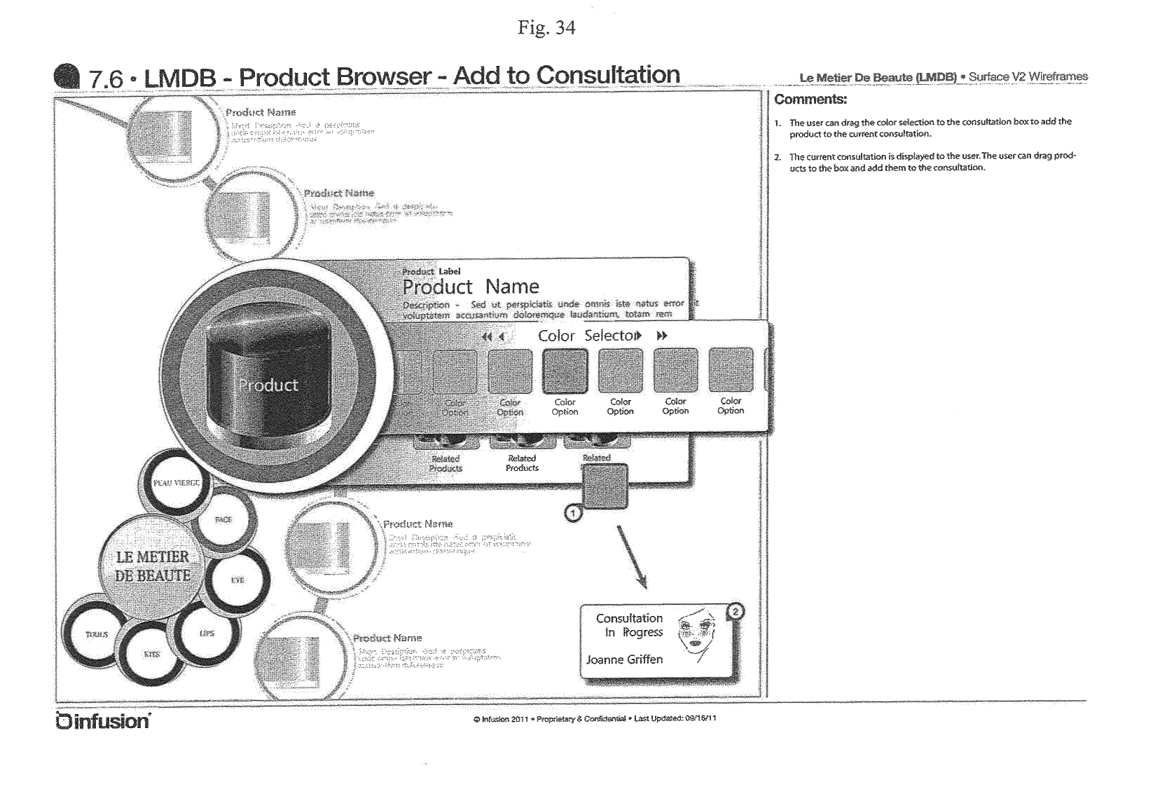

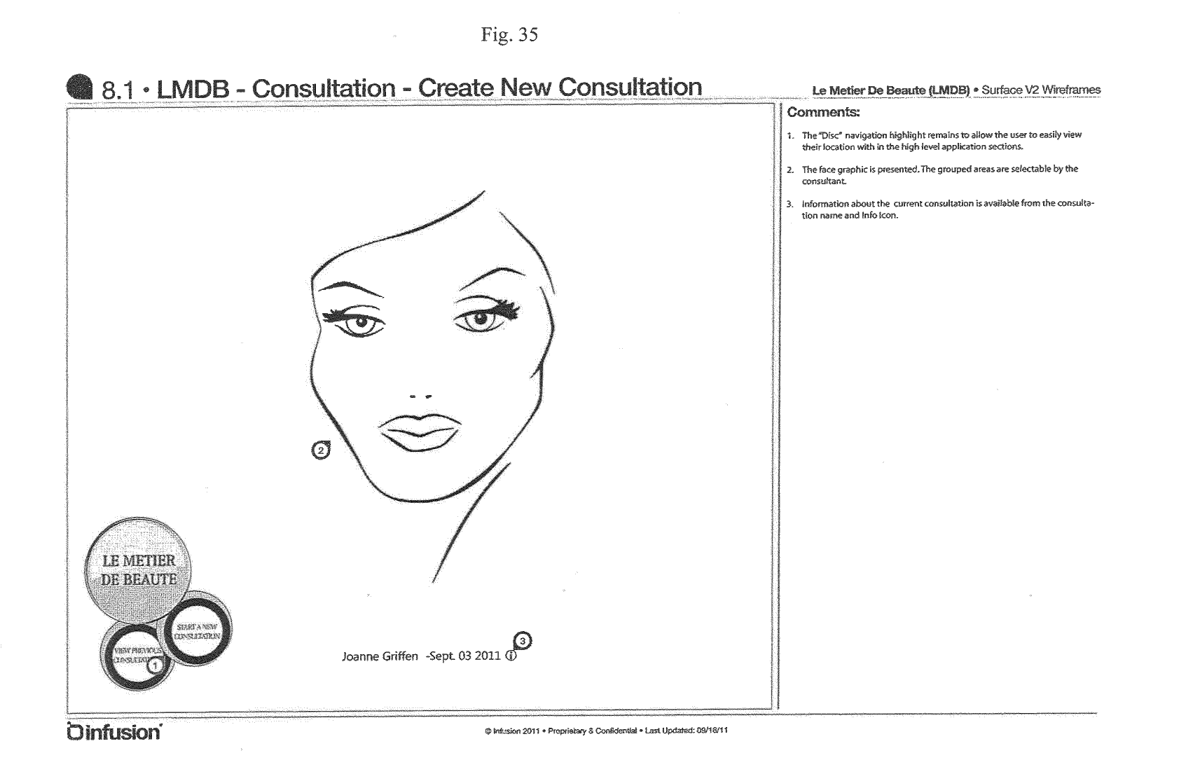

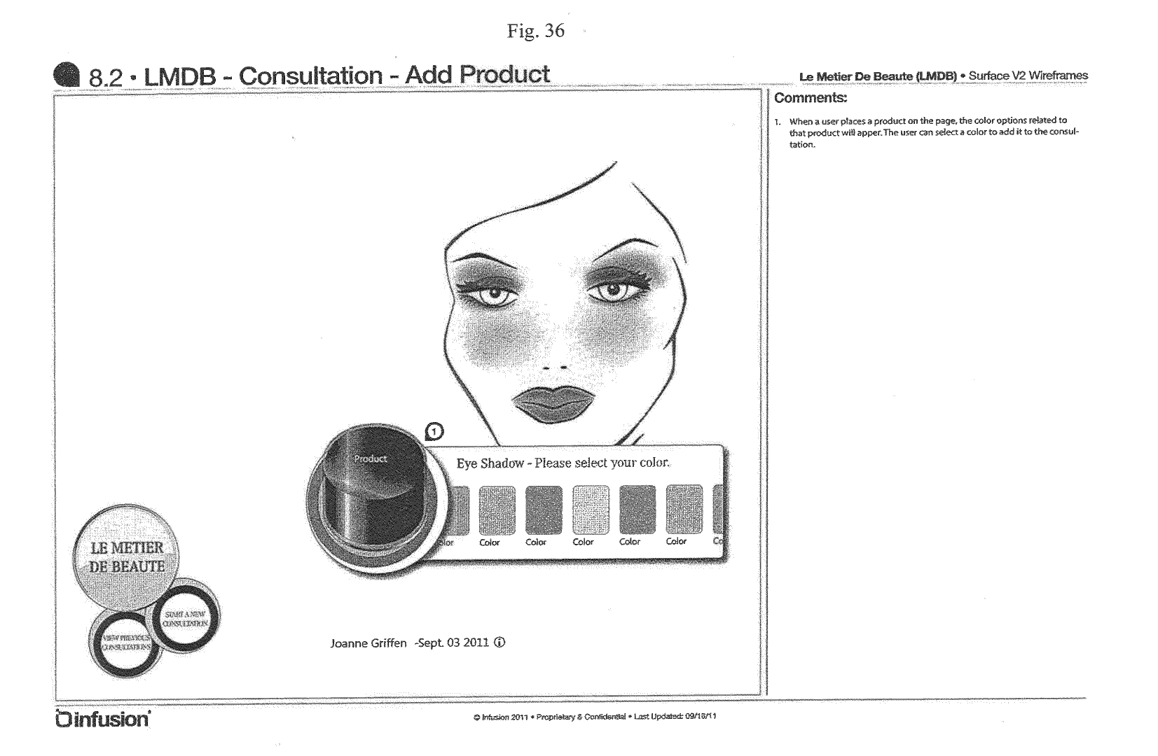

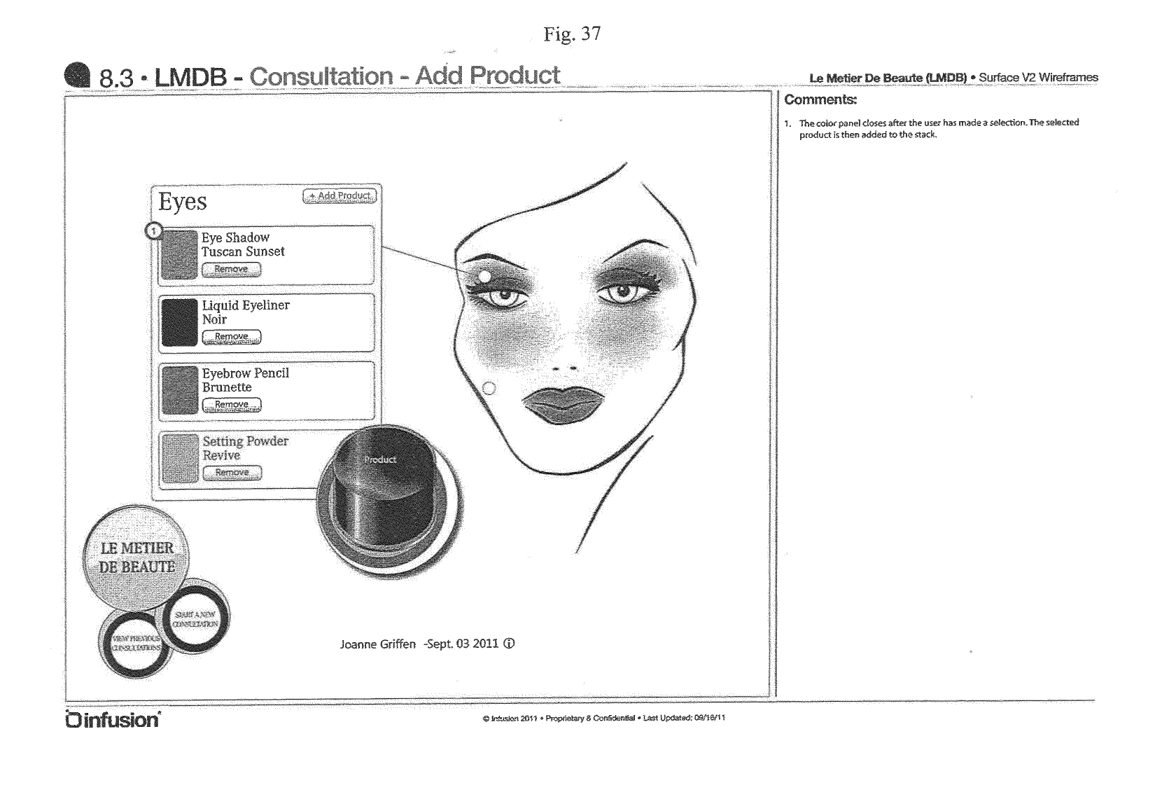

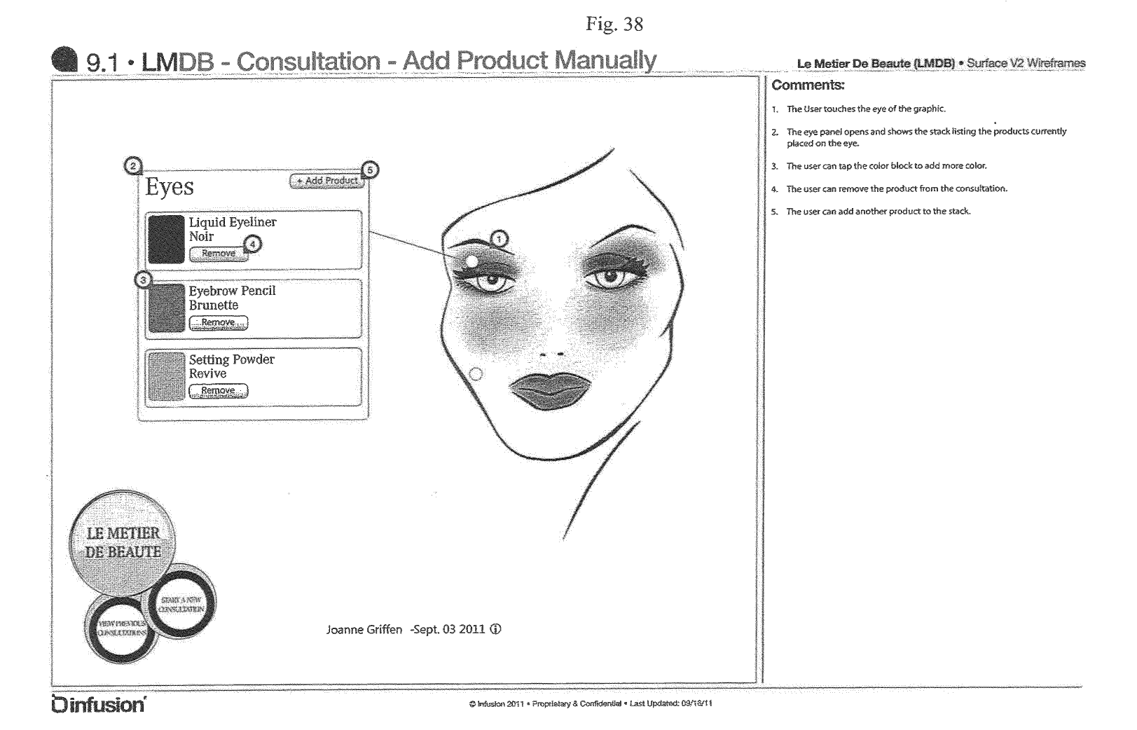

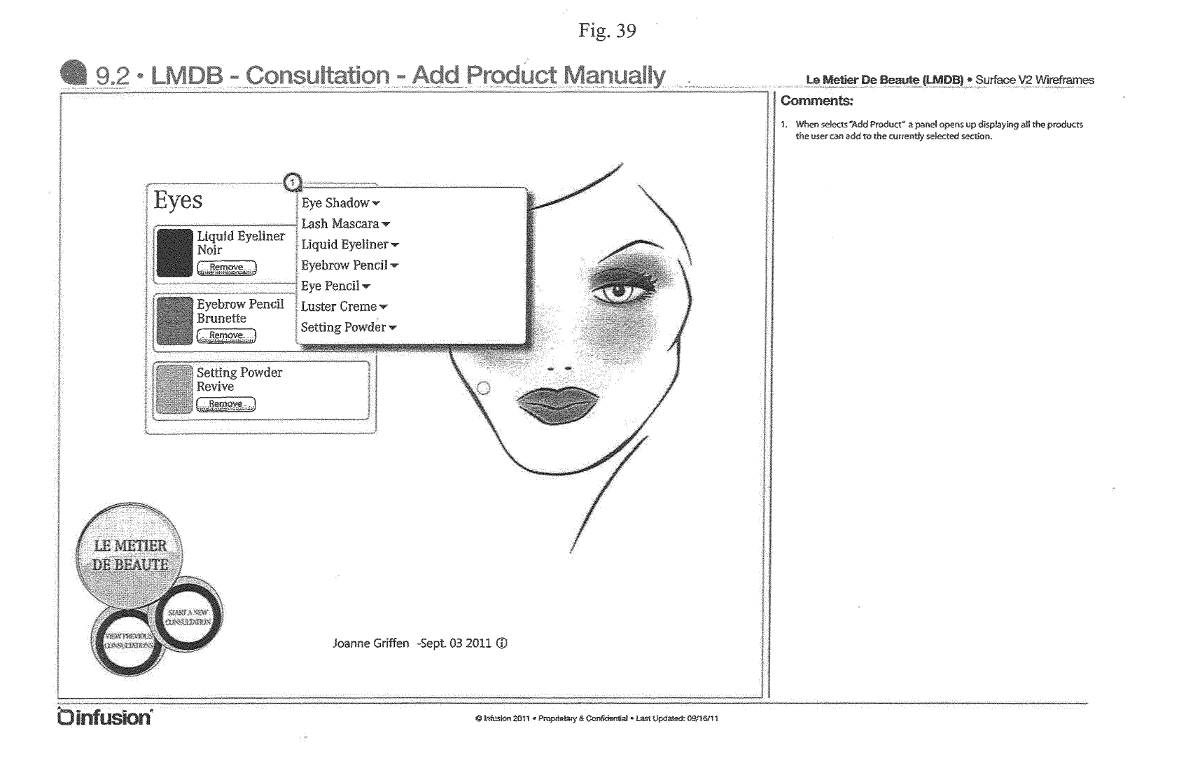

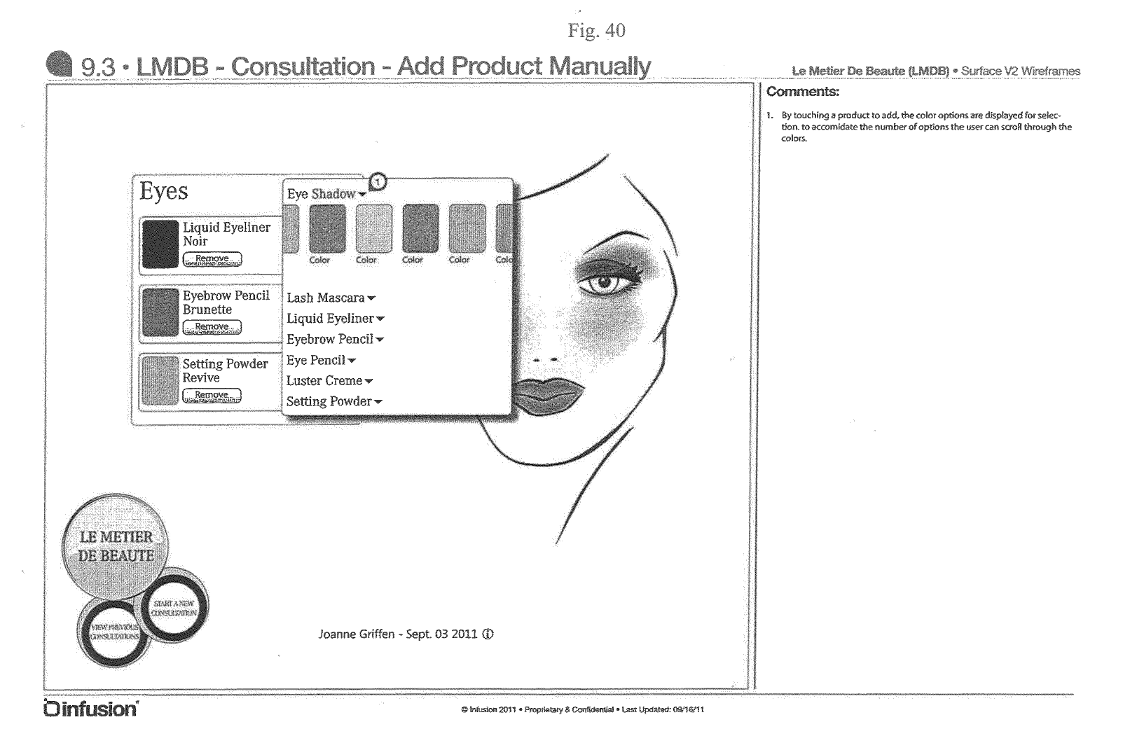

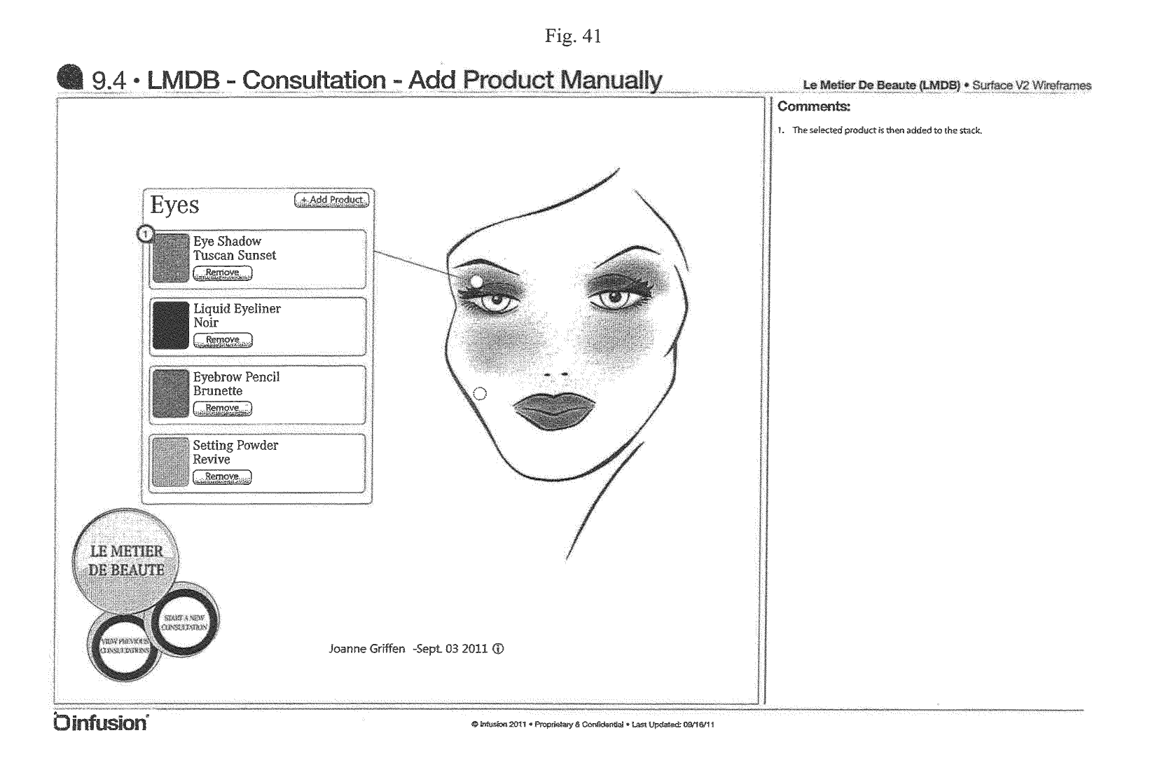

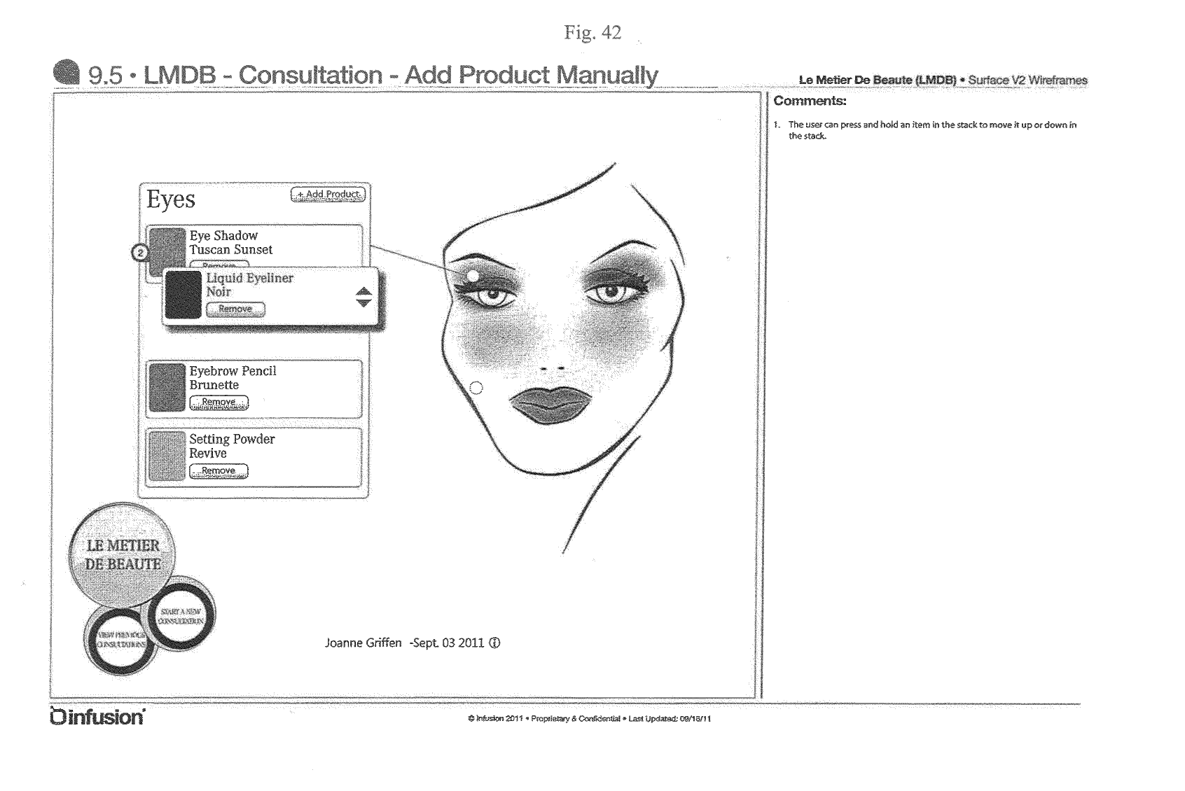

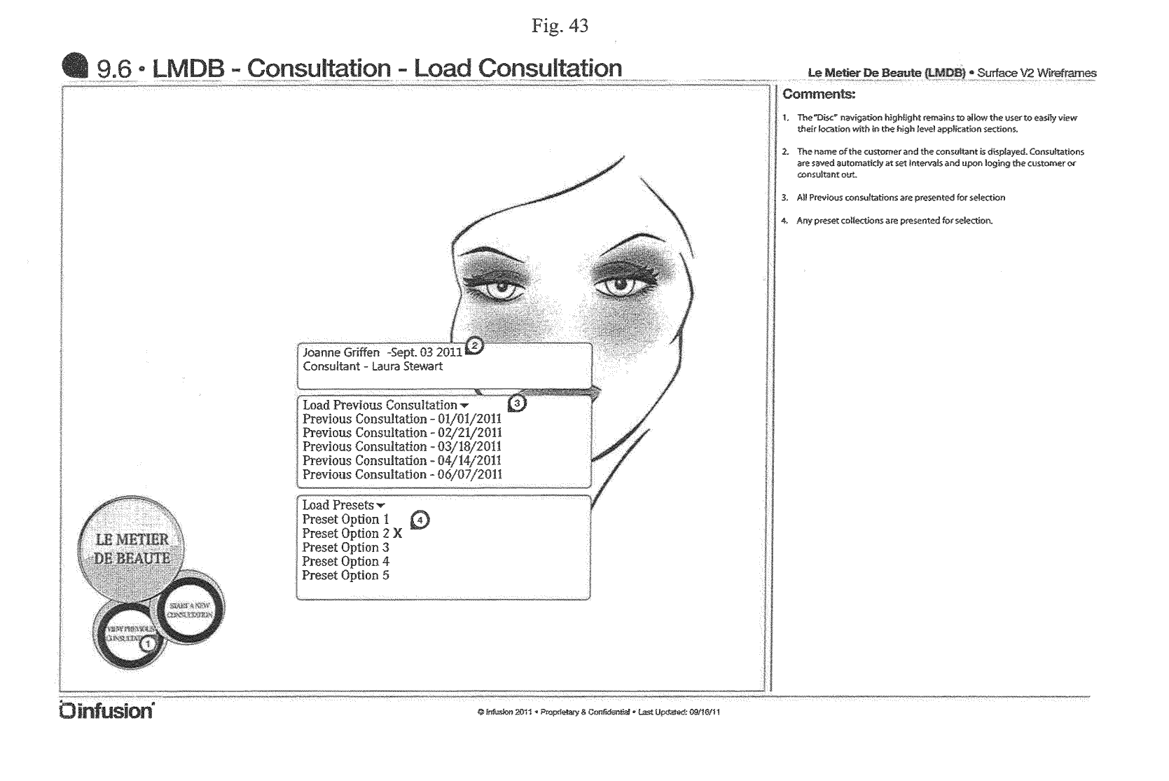

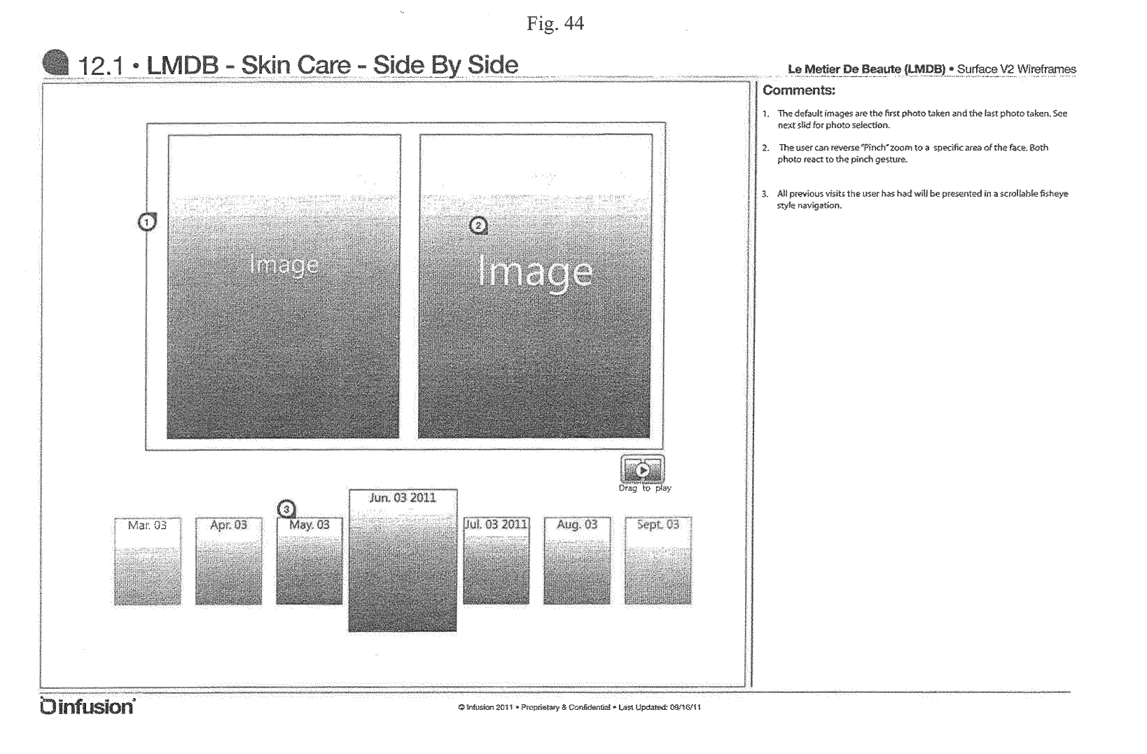

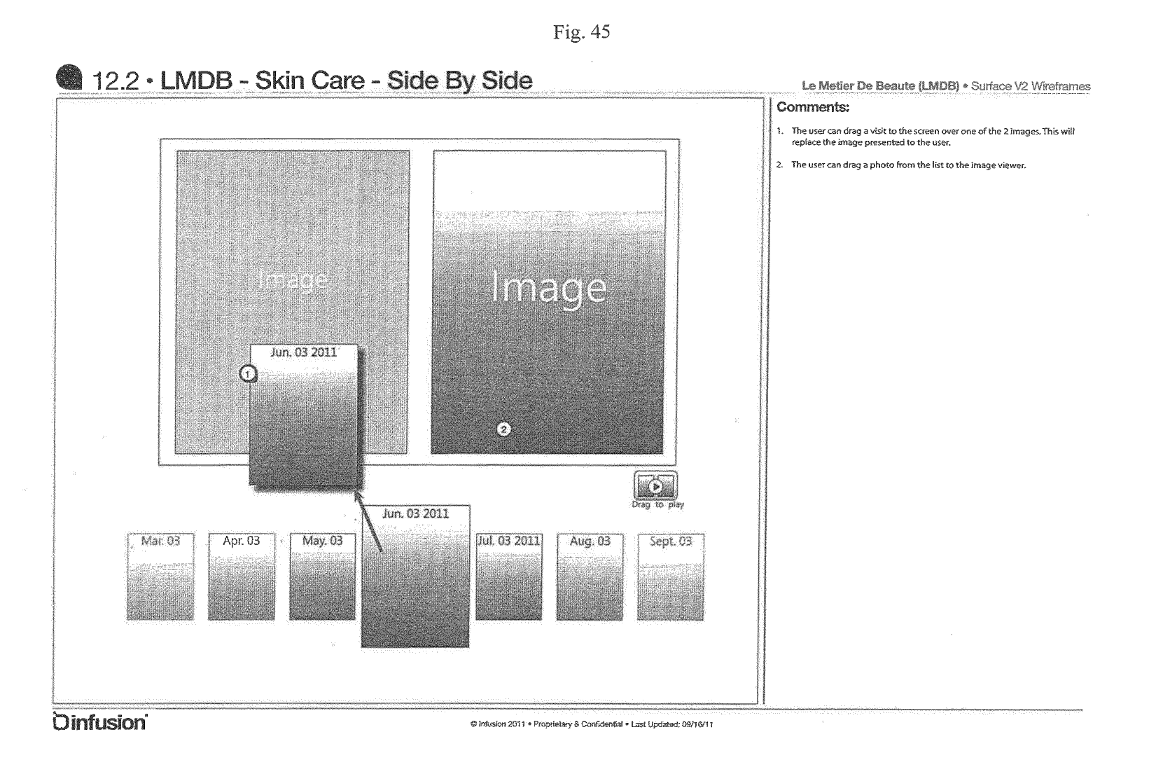

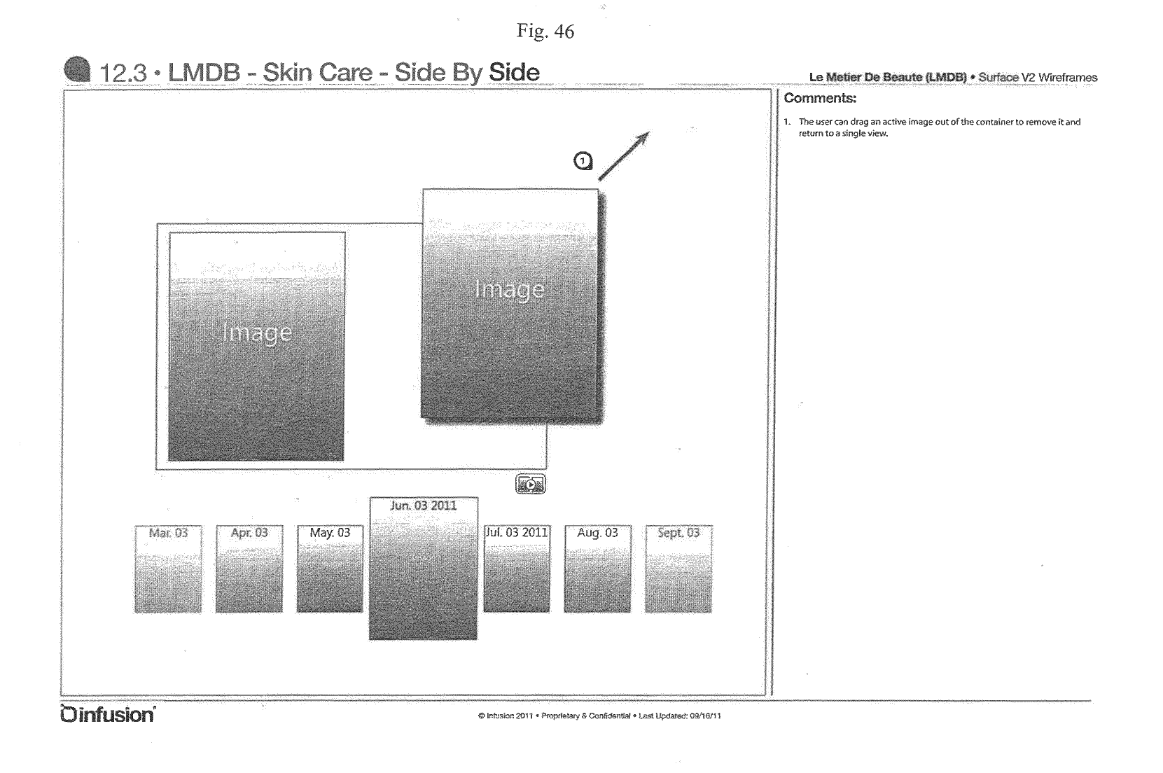

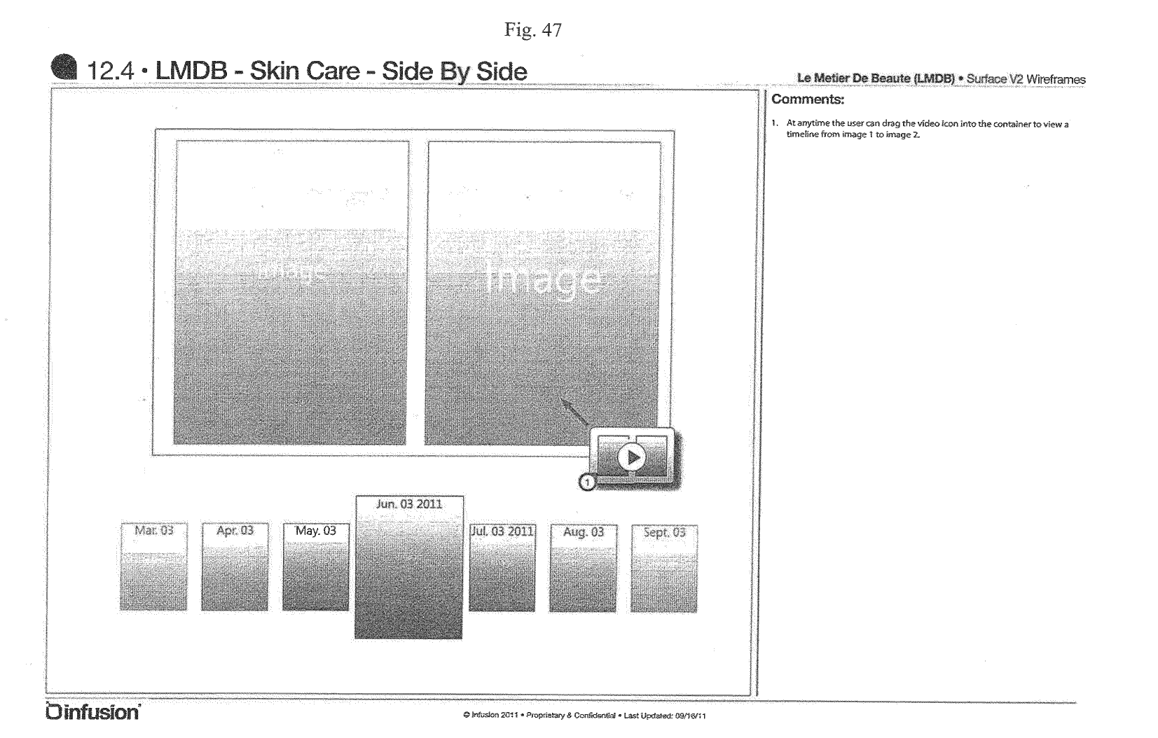

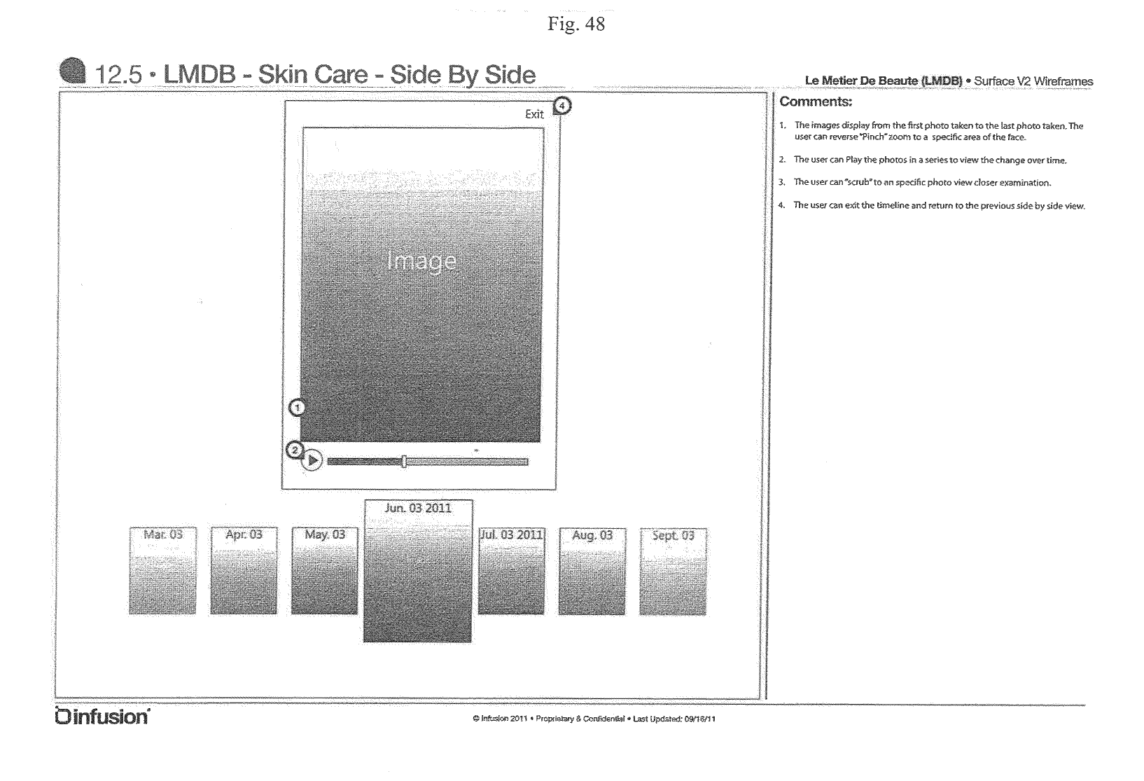

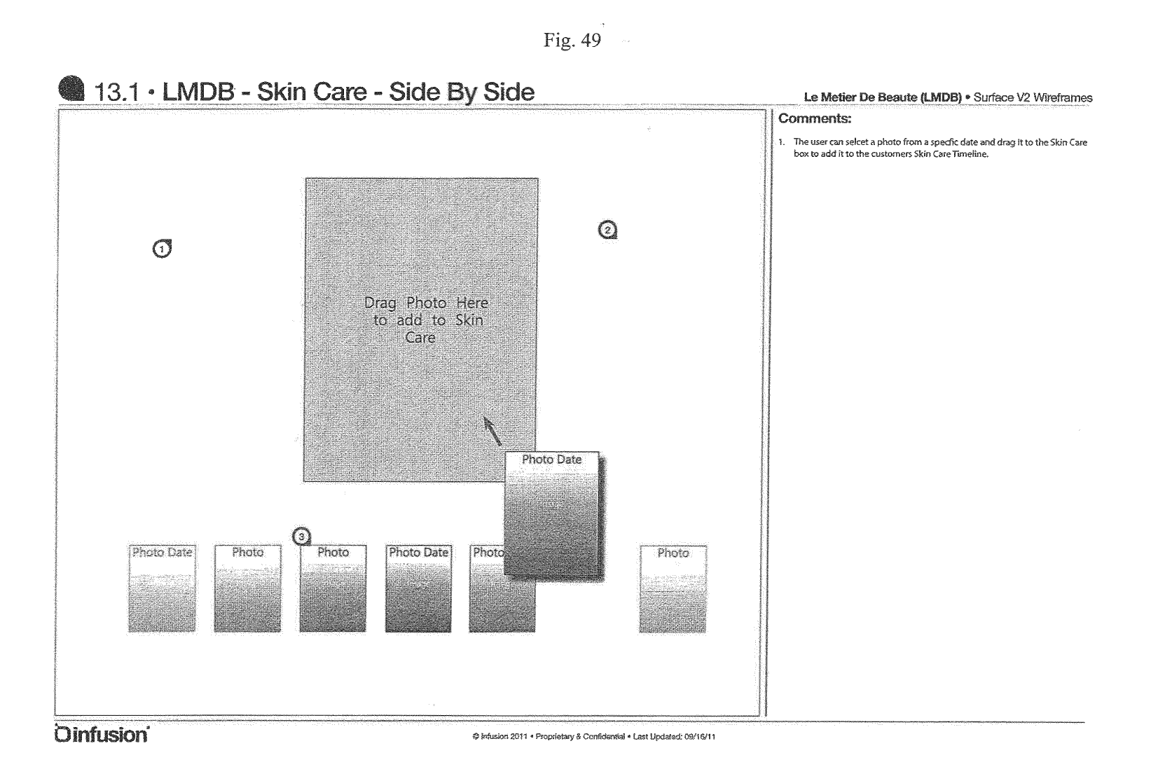

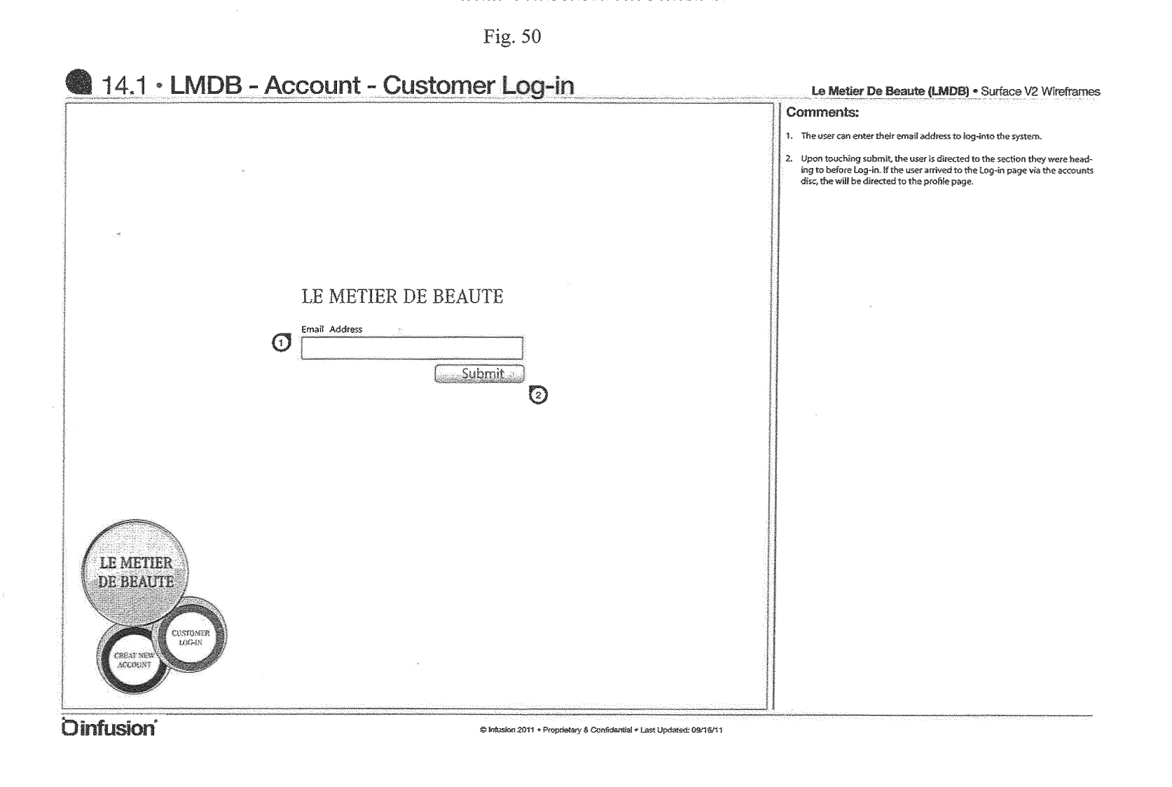

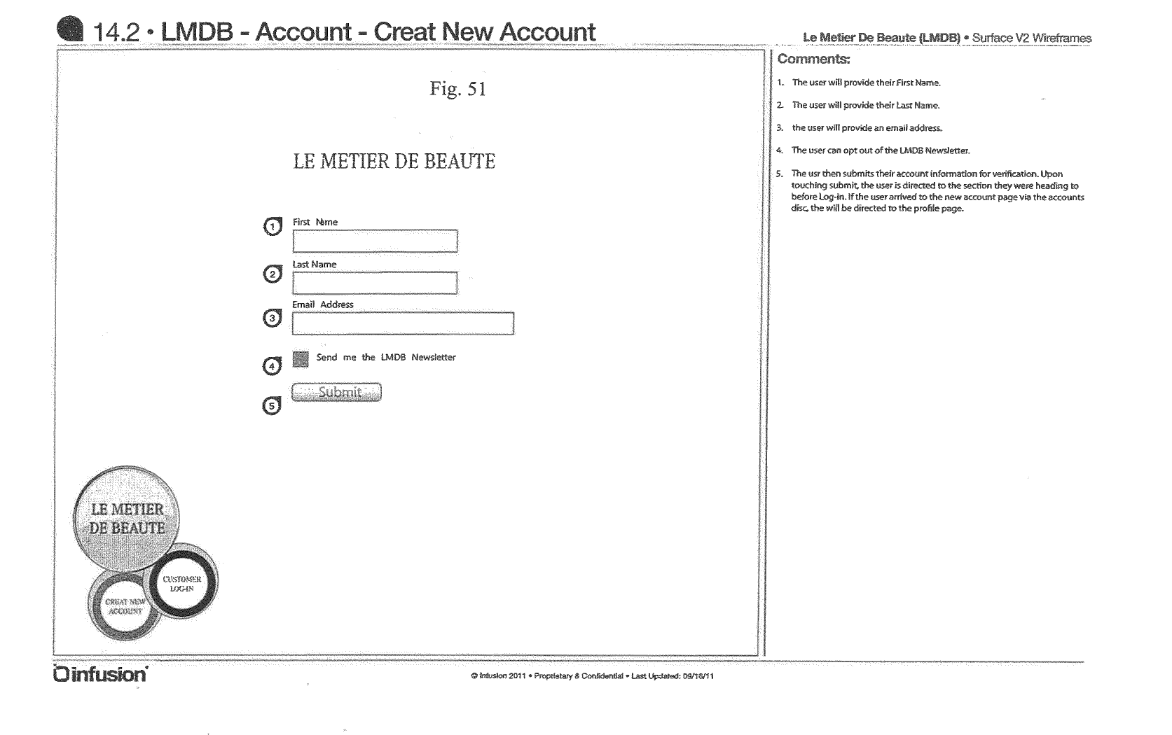

FIGS. 19-51 show various static interfaces with some of the embodiments of the system.

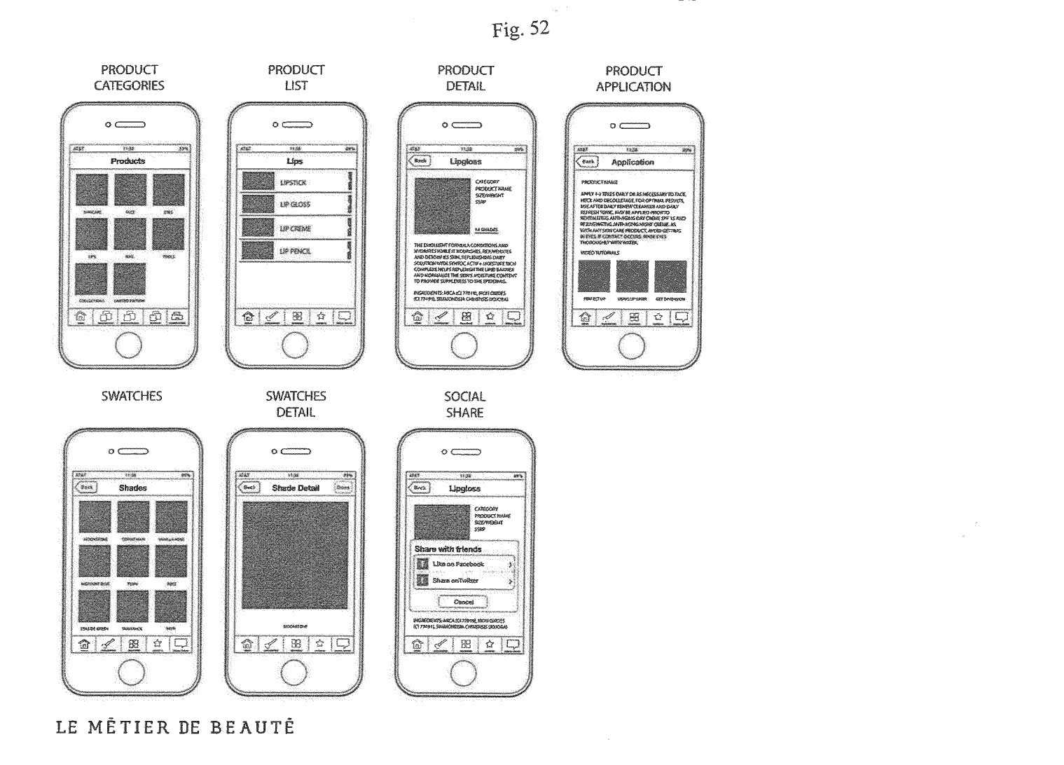

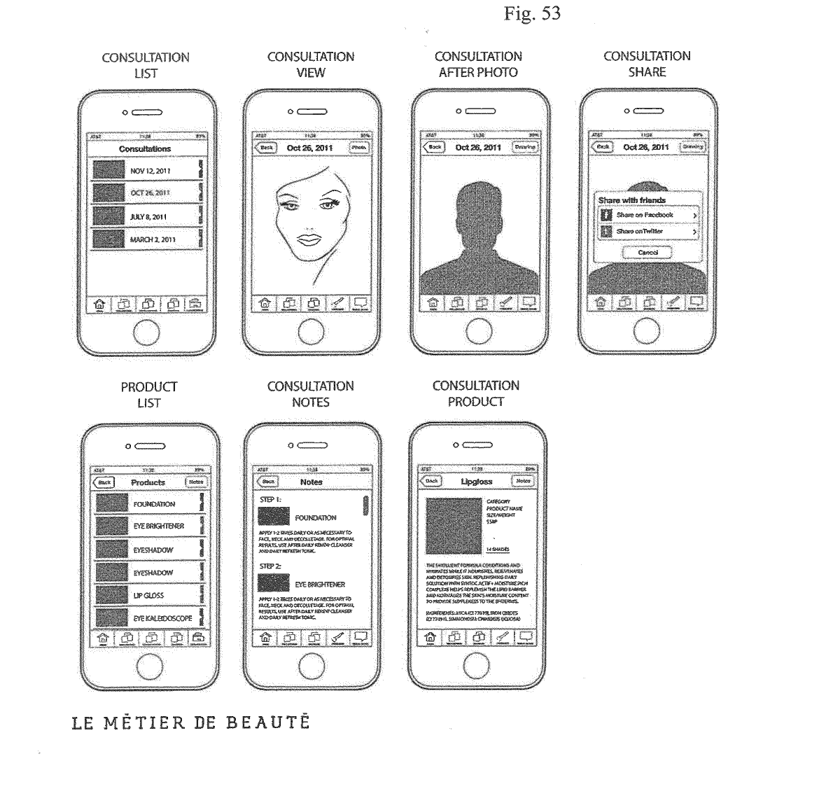

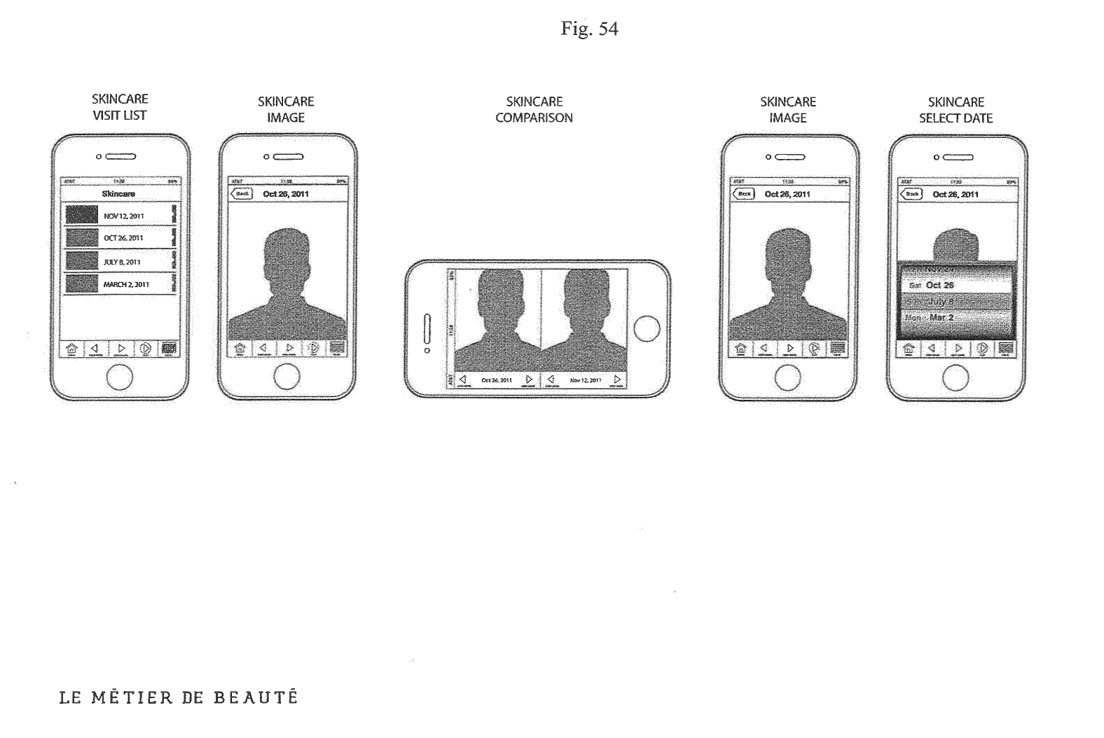

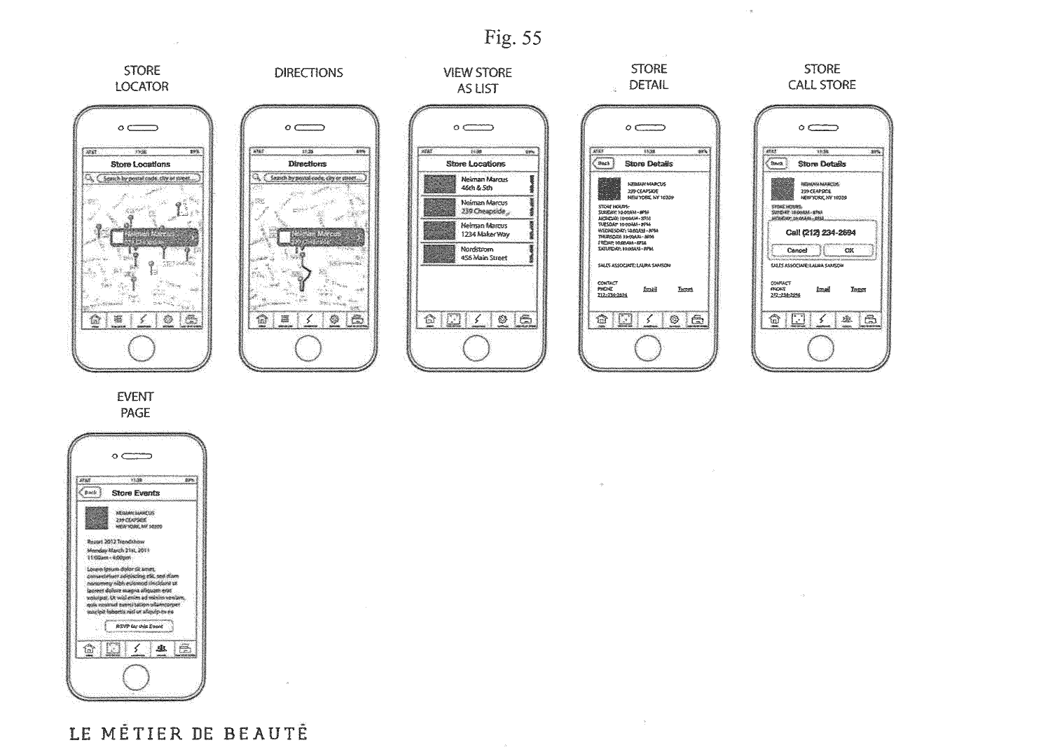

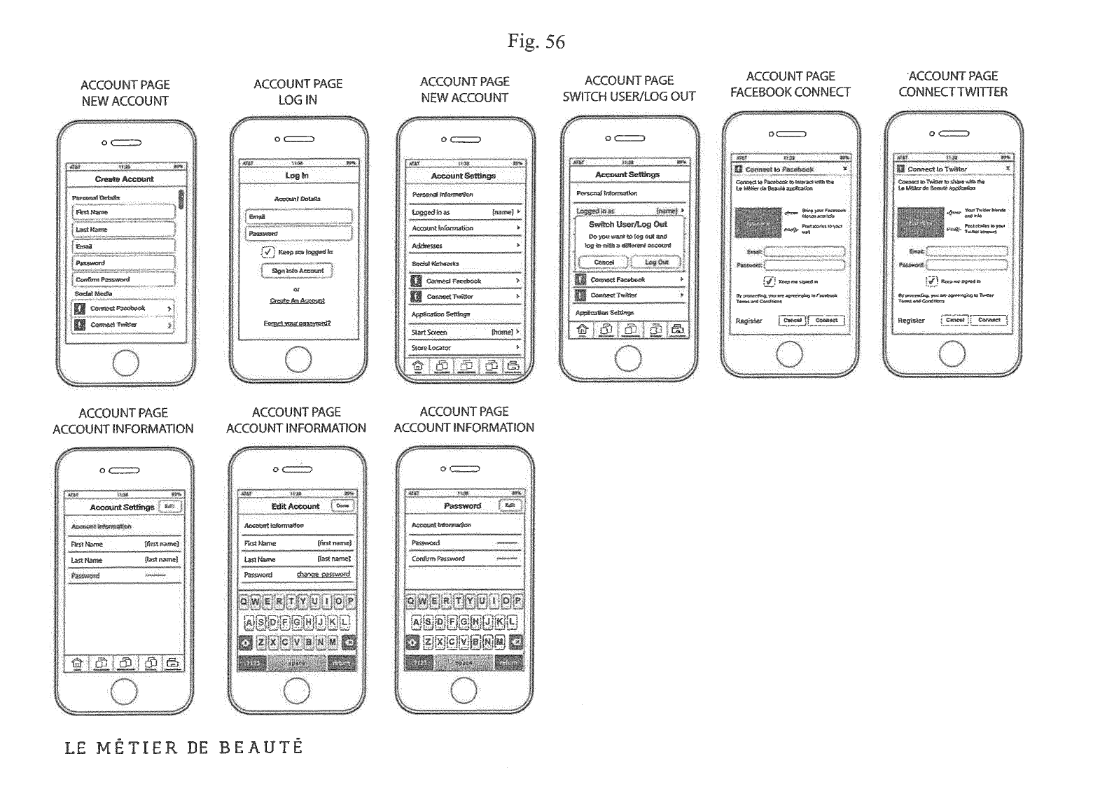

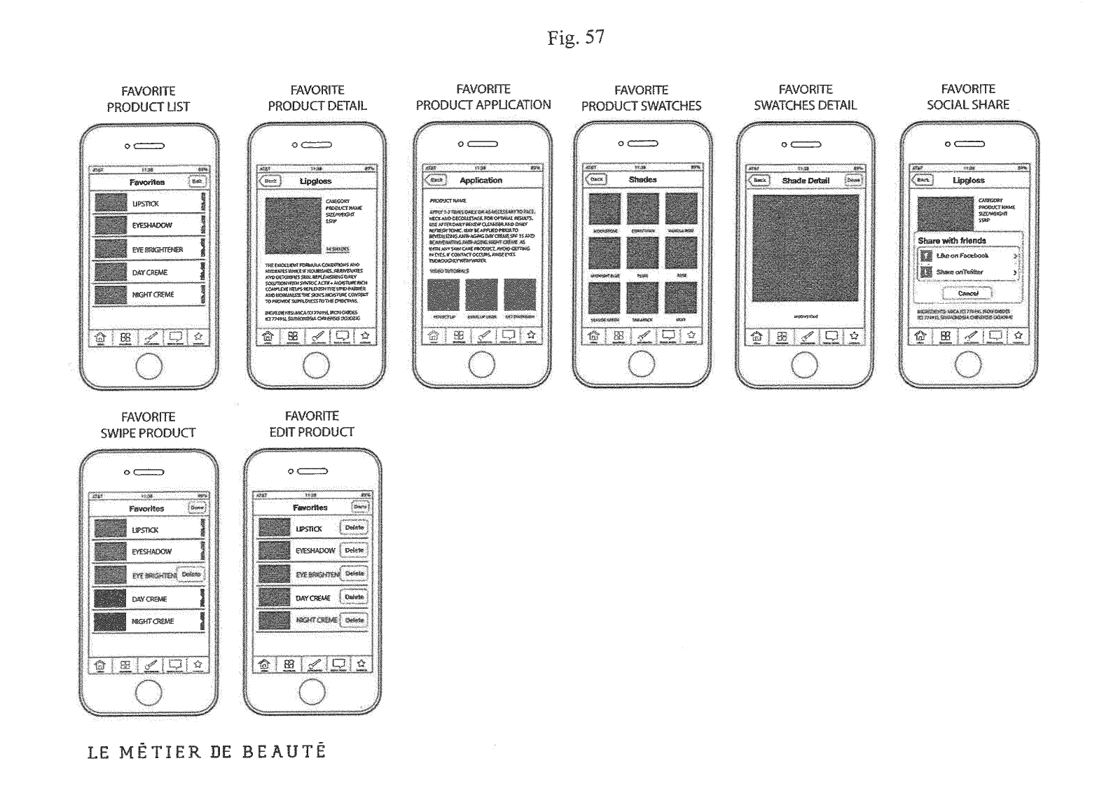

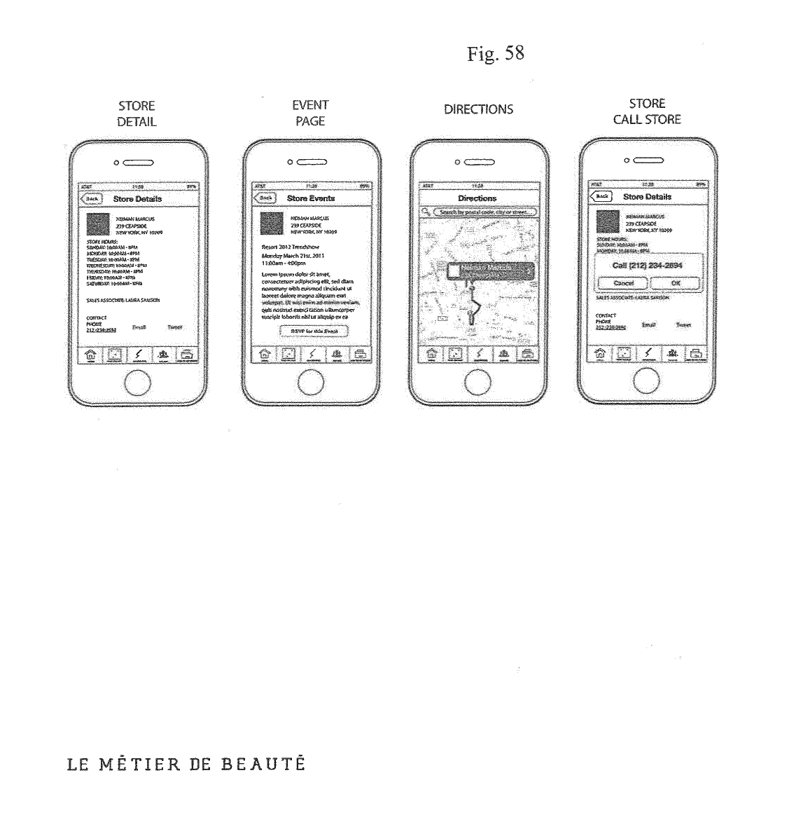

FIGS. 52-58 show various static interfaces with a mobile communication device in some embodiments of the system.

FIG. 59 is omitted.

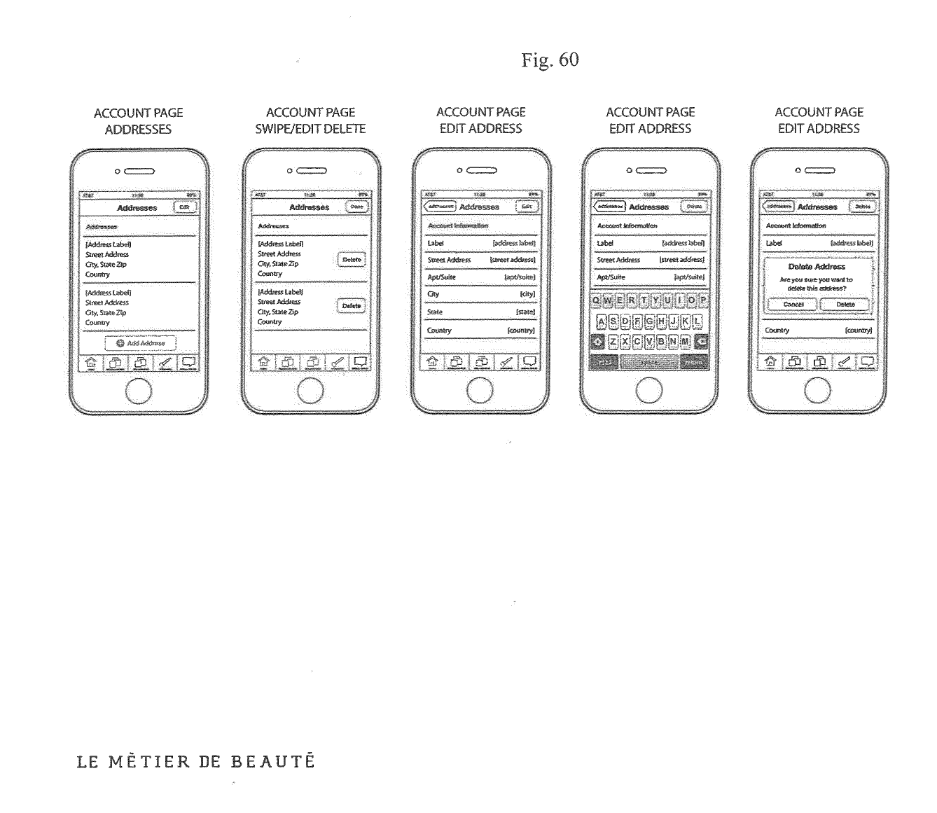

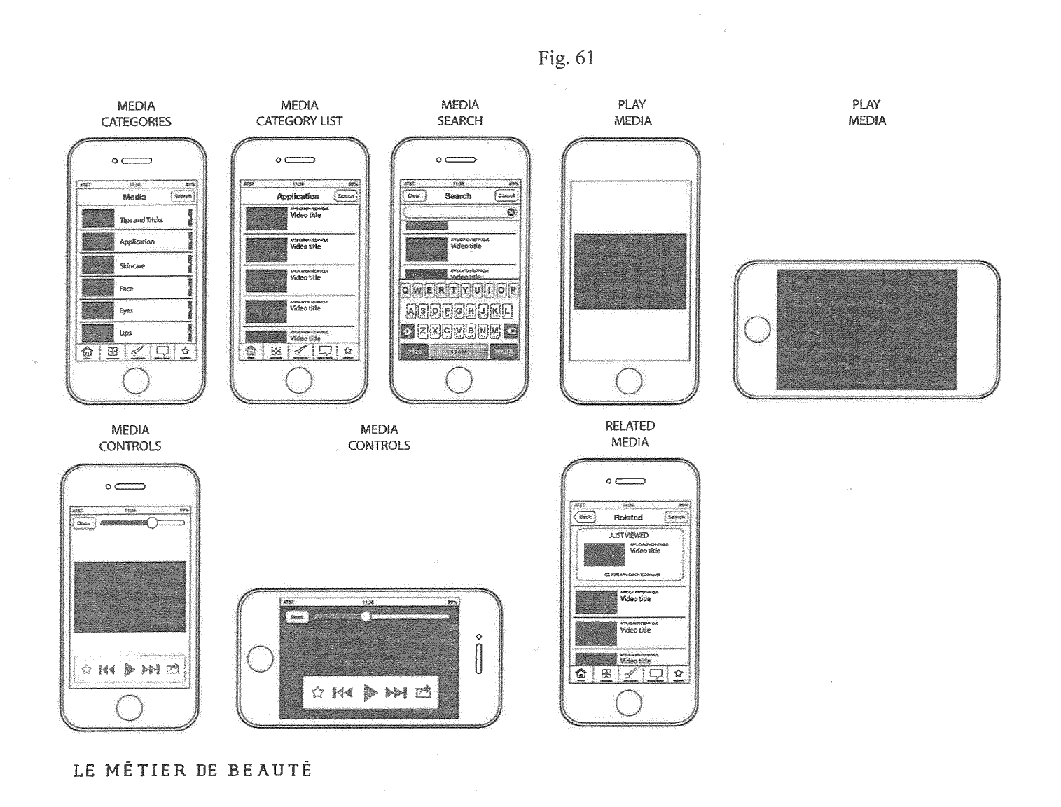

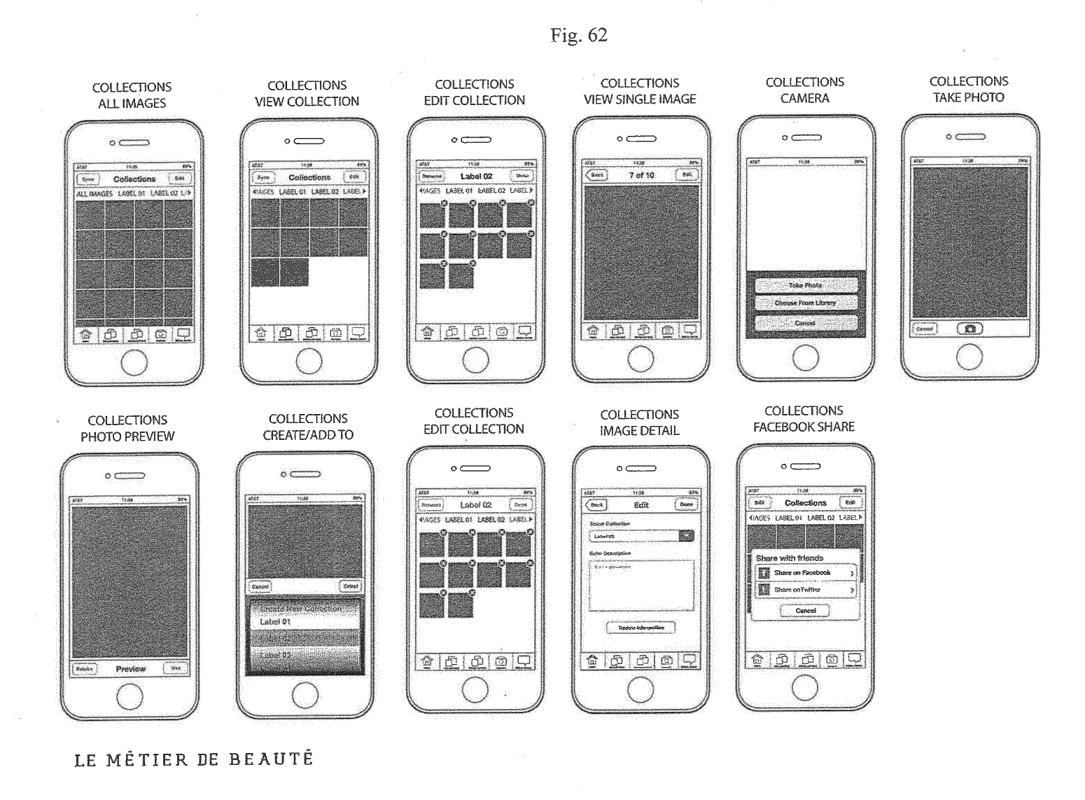

FIGS. 60-62 show various static interfaces with a mobile communication device in some embodiments of the system.

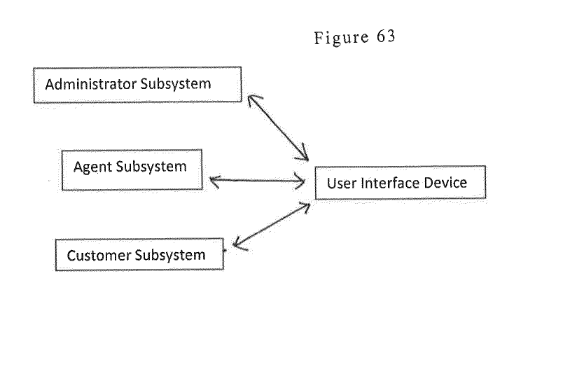

FIG. 63 shows the three subsystems (Administrator, Agent, and Customer) sending and receiving data to a user interface device. In the preferred embodiments, the output of the system is displayed on a user interface device.

1. A system for product promotion comprising:
A. an administrator subsystem that provides input wherein the administrator subsystem includes at least three of the following modules:
i. an access control module,
ii. an agent analytics modules,
iii. a collection analytics module,
iv. a content management module,
v. a customer analytics module,
vi a product analytics module,
vii. a product promotion module, and
viii. a product offer module;
B. an agent subsystem that provides input wherein the agent subsystem includes at least two of the following modules:
i. a collection display module,
ii. a configurator module,
iii. a guide module, and
iv. a needs/suitability analyzer module;
and
C. a customer subsystem that provides input wherein the customer subsystem includes at least one of the following modules:
i. a collection module
ii. a configurator display module
iii. a needs/suitability analyzer display module,
and wherein data provided to or generated from the system is stored on a non-transitory computer readable medium.

2. The system of claim 1 wherein the product promotion module selects a product to be promoted through the product offer module and the input of the collection analytics module or the products analytics module.

3. The system of claim 1 wherein the configurator module and configurator display module comprises a my face module.

4. The system of claim 3 wherein the my face module comprises a virtual face or a real image of the customer's face.

5. The system of claim 3 wherein the my face module comprises a series of images of a virtual face or a real image of the customer's face during a single consultation.

6. The system of claim 4 wherein product information is displayed according to the input of the my face module.

7. The system of claim 1 wherein input from a skin analysis is additionally included.

8. A method for promoting a product comprising:
A. receiving input from a administrator subsystem, an agent subsystem, and a customer subsystem of claim 1,
B. displaying a product promotion according to the inputs of the administrator subsystem, an agent subsystem, and a customer subsystem on a user interfacing device.

9. A system for product promotion on a computing device comprising:
A. a customer subsystem configured to collect customer preferences with respect to a plurality of products;
B. an agent subsystem configured to provide information to the customer subsystem about a product or product implementation of the plurality of products; and
C. an administrator subsystem configured to analyze interactions facilitated by the agent subsystem and to analyze customer actions using the customer subsystem, wherein the administrator subsystem selects a product promotion based on the interactions and customer actions.

10. The system of claim 9, wherein the administrator subsystem is configured to override the information from the agent subsystem.

11. The system of claim 9, further comprising a display of product information corresponding to the selected product promotion.
